(19) United States
(12) Patent Application Publication
(10) Pub. No.: US 2026/0220296 A1
(43) Pub. Date: Jul. 30, 2026

(54) Artificial Intelligence Agent Platform with a Real-Time Security and Compliance Enforcement Layer

(71) Applicant: Intellectus Partners, LLC, San Francisco, CA (US)

(72) Inventor: David J. La Placa, San Francisco, CA (US)

(21) Appl. No.: 19/570,053

(22) Filed: Mar. 17, 2026

Related U.S. Application Data
(63) Continuation-in-part of application No. 19/252,577, filed on Jun. 27, 2025, now Pat. No. 12,579,226.
Application No. 19/252,577 is a continuation-in-part of application No. 19/006,533, filed on Dec. 31, 2024.
Application No. 19/006,533 is a continuation-in-part of application No. 18/407,415, filed on Jan. 8, 2024, now Pat. No. 12,450,570.

(51) Int. Cl. G06F 21/62

(52) U.S. Cl. CPC G06F 21/6227

(57) ABSTRACT

A system and method for enforcing real-time security and compliance during operation of artificial intelligence (Al) agent platforms, including platforms employing digital twin Al agents. The system receives queries directed to deployed Al agent instances along with user and session metadata, then classifies each query to generate a security decision record that governs all subsequent processing. Based on the security decision record, the system constructs a prompt package containing only authorized contextual data and routes the prompt package to either a private model execution environment within secure infrastructure or an external model accessed over a network. After the Al model generates a candidate output, a response compliance layer analyzes the output to detect violations of security, privacy, or regulatory constraints. When violations are detected, the system applies enforcement actions such as redaction, rewriting, or blocking. Only outputs satisfying all applicable requirements are released for delivery to the user.

### CROSS-REFERENCE TO RELATED APPLICATIONS

Priority is claimed in the application data sheet to the following patents or patent applications, each of which is expressly incorporated herein by reference in its entirety:

19/252,577

19/006,533

18/407,415

### BACKGROUND OF THE INVENTION

### Field of the Art

The present invention relates to the field of artificial intelligence-driven digital twin platforms, and more specifically to systems and methods for enforcing real-time security, privacy, and regulatory compliance during query processing, model execution, and response delivery within deployed digital twin environments.

### Discussion of the State of the Art

The increasing deployment of artificial intelligence systems within digital twin platforms has enabled organizations to model, analyze, and interact with complex real-world entities using automated reasoning and generative techniques. Digital twins are now commonly used to represent enterprises, financial accounts, operational environments, and subject-matter experts, and are frequently coupled with advanced artificial intelligence models to provide interactive analysis, recommendations, forecasting, and decision support. Recent advances in large language models and other generative architectures have further expanded the scope and usability of such platforms by enabling natural language interaction and synthesis across large and heterogeneous data sets.

However, the integration of artificial intelligence models into digital twin platforms has introduced significant technical challenges related to data security, privacy protection, and regulatory compliance. Many modern artificial intelligence systems employ hybrid execution architectures that combine private, self-hosted models with external or third-party models accessed over a network. While such hybrid architectures can improve performance, scalability, and cost efficiency, they also create substantial risk that sensitive or regulated data may be transmitted outside secure infrastructure, processed in unauthorized environments, or inadvertently disclosed in generated outputs. These risks are particularly acute in regulated industries such as financial services, healthcare, and critical infrastructure, where strict controls govern data handling, automated decision-making, and supervisory oversight.

Conventional security mechanisms used in digital twin and artificial intelligence systems typically rely on static access controls, predefined permissions, or perimeter-based defenses. Such approaches are poorly suited to artificial intelligence-driven systems in which each user query may dynamically combine multiple data sources, invoke different models, and generate novel content that did not previously exist. In these systems, controlling access to stored data alone is insufficient to ensure security and compliance. Instead, security and regulatory constraints must be enforced dynamically during query processing, model execution, and response generation. Existing systems generally lack mechanisms to classify individual queries in real time, constrain context construction and model routing based on that classification, and validate generated outputs before delivery to users.

Additionally, current digital twin platforms often lack robust mechanisms for producing auditable records that capture the security and compliance decisions made during artificial intelligence execution. Regulatory frameworks increasingly require detailed evidence of how automated systems operate, including what data was accessed, which models were used, what policies were applied, and how outputs were filtered or constrained. Without integrated audit generation and tamper-evident recordkeeping, organizations face significant challenges in demonstrating compliance, conducting forensic analysis, or supporting supervisory review.

Accordingly, what is needed is a digital twinning platform that incorporates a real-time security and compliance enforcement layer capable of dynamically classifying queries and associated metadata, controlling contextual data access and artificial intelligence model routing based on policy-driven decisions, validating and enforcing compliance on generated outputs prior to release, and generating auditable records of system behavior, thereby enabling secure and compliant artificial intelligence execution within deployed digital twin environments while supporting hybrid model architectures.

### SUMMARY OF THE INVENTION

Accordingly, the inventor has conceived and reduced to practice a computing system and method for an artificial intelligence agent platform with a real-time security and compliance enforcement layer. The system introduces a runtime security and compliance enforcement layer that intercepts and governs queries, contextual data access, artificial intelligence model execution, and response delivery associated with digital twins. Rather than relying on static access controls or preconfigured permissions, the platform dynamically classifies each query and its associated metadata to generate a security decision record that drives least-privilege context construction, policy-driven model routing, post-generation response validation, and controlled release of outputs. This architecture enables hybrid execution across private and external artificial intelligence models while preventing unauthorized data exposure, enforcing regulatory constraints, and maintaining auditable records of system behavior at the level of individual interactions.

In an embodiment, the runtime security and compliance enforcement layer disclosed herein is applicable to artificial intelligence agent platforms generally, including platforms in which deployed artificial intelligence agent instances are not configured as digital twins of specific subjects. The security classification, least-privilege context construction, policy-driven routing, post-generation response compliance enforcement, and audit generation mechanisms disclosed herein address technical challenges common to any artificial intelligence platform in which queries are processed using contextual data retrieved from one or more data sources, in which one or more artificial intelligence models generate candidate outputs in response to such queries, and in which generated outputs must satisfy security, privacy, or regulatory requirements prior to delivery. Such platforms include, without limitation, agentic artificial intelligence platforms in which one or more autonomous or semi-autonomous artificial intelligence agents perform tasks or generate responses on behalf of users, retrieval-augmented generation systems in which artificial intelligence models generate outputs based on dynamically retrieved contextual data, multi-agent orchestration platforms in which multiple artificial intelligence agents interact and coordinate to accomplish tasks, enterprise artificial intelligence assistants configured to access organizational knowledge bases and respond to user queries, and artificial intelligence-driven decision support systems configured to generate recommendations or analyses subject to regulatory or policy constraints. In such embodiments, references herein to a deployed digital twin instance may be understood more broadly as references to a deployed artificial intelligence agent instance, and the security and compliance enforcement mechanisms disclosed herein operate in the same manner regardless of whether the deployed artificial intelligence agent instance is configured as a digital twin of a specific subject.

Accordingly, while the embodiments described in this disclosure are presented primarily in the context of a digital twinning platform, the disclosed architecture is not limited to digital twinning and encompasses any artificial intelligence agent platform in which runtime security and compliance enforcement is applied to query processing, model execution, and response generation. In an embodiment, a computing system for a platform for digitally twinning subjects into artificial intelligence agents includes one or more hardware processors configured to receive, through a client engagement layer, a query directed to a deployed digital twin instance together with metadata identifying a user, a tenant, and a session. The system classifies the query and metadata using a security classification engine to generate a security decision record that specifies one or more security, privacy, or compliance parameters, and constructs a prompt package that includes only contextual data elements authorized by that security decision record. The system routes the prompt package, based on the security decision record, to a private model execution environment hosted within secure infrastructure, an external model execution environment accessed over a network, or a combination thereof, generates a candidate output using an artificial intelligence model within the routed execution environment, analyzes the candidate output using a response compliance layer to detect violations of security, privacy, or regulatory constraints, applies one or more enforcement actions when a violation is detected, and releases to the client engagement layer only a candidate output that satisfies applicable security, privacy, and regulatory requirements.

In an aspect of an embodiment, the computing system further generates, for each processed query, an audit artifact that records the security decision record, routing decisions, model identifiers, policy version identifiers, and any enforcement actions applied, and stores the audit artifact in a tamper-evident data store using cryptographic techniques.

In an aspect of an embodiment, classifying the query and metadata includes applying a machine-learned classifier to identify a sensitive information category and validating an output of the machine-learned classifier against one or more explicit policy rules to generate the security decision record.

In an aspect of an embodiment, constructing the prompt package includes retrieving candidate contextual data elements from a data store associated with the deployed digital twin instance, evaluating each candidate contextual data element against the security decision record, and excluding from the prompt package any candidate contextual data element that is not authorized.

In an aspect of an embodiment, routing the prompt package includes routing execution to the private model execution environment when a sensitivity label specified in the security decision record indicates the presence of protected information, and applying one or more required data transformations to the prompt package prior to routing execution to the external model execution environment.

In an aspect of an embodiment, when the security classification engine cannot classify the query with a confidence level meeting a predefined threshold, the system defaults to a fail-closed mode in which execution is routed exclusively to the private model execution environment. In an aspect of an embodiment, the computing system further receives learned information derived from interactions with a deployed digital twin instance, places the learned information in a quarantine state, evaluates the learned information against the security decision record during the quarantine state, and promotes the learned information for use in subsequent query processing only when the learned information satisfies requirements specified in the security decision record.

In an aspect of an embodiment, routing the prompt package includes executing a hybrid execution strategy in which the private model execution environment processes contextual data elements associated with a sensitivity label to generate an intermediate representation, and the external model execution environment generates the candidate output based on the intermediate representation.

Computer-implemented method embodiments are provided that correspond directly to the described computing system embodiments and operate in an equivalent manner to perform real- time security classification, policy-driven routing, compliant artificial intelligence execution, response enforcement, audit generation, and secure learning integration, and such method embodiments are not restated separately herein.

### BRIEF DESCRIPTION OF THE DRAWING FIGURES

FIG. 1 is a block diagram illustrating an exemplary system architecture of a digital twinning platform with an integrated real-time security and compliance enforcement layer.

FIG. 2 is a block diagram illustrating exemplary internal components and data flows of a security classification engine used to derive policy-driven security decision records.

FIG. 3 is a block diagram illustrating exemplary architecture of a secure routing and context construction subsystem configured to assemble least-privilege prompt packages and determine execution routing.

FIG. 4 is a block diagram illustrating exemplary architecture of an artificial intelligence execution layer including private, external, and hybrid execution environments.

FIG. 5 is a block diagram illustrating exemplary architecture of a response compliance layer configured to analyze candidate outputs and enforce security, privacy, and regulatory constraints prior to release.

FIG. 6 is a block diagram illustrating exemplary architecture of an audit and evidence subsystem configured to generate, correlate, and store tamper-evident audit artifacts.

FIG. 7 is a block diagram illustrating exemplary architecture of a secure learning and feedback integration subsystem configured to quarantine, evaluate, and control promotion of learned information.

FIG. 8 is a flow diagram illustrating exemplary end-to-end processing of a query through a security and compliance enforcement layer from ingestion through response disposition.

FIG. 9 is a flow diagram illustrating exemplary fail-closed enforcement decision paths invoked at multiple processing stages under conditions of uncertainty or constraint.

FIG. 10 is a flow diagram illustrating exemplary secure learning and feedback integration processing including validation, quarantine, controlled promotion, and audit generation.

FIG. 11 illustrates an exemplary computing environment on which an embodiment described herein may be implemented.

### DETAILED DESCRIPTION OF THE INVENTION

The inventor has conceived and reduced to practice a system and method for an artificial intelligence agent platform with a real-time security and compliance enforcement layer. The disclosed system operates as a runtime enforcement architecture integrated into a digital twinning platform in which deployed digital twin instances interact with users, applications, or automated agents through artificial intelligence models. Rather than relying on static access controls or preconfigured permissions, the system evaluates each interaction dynamically and enforces policy-driven controls during query processing, contextual data retrieval, model execution, response generation, and learning updates. This approach enables secure use of private and external artificial intelligence models while preventing unauthorized data exposure and supporting auditable, compliant operation in regulated and unregulated environments.

The security classification, routing, compliance enforcement, and audit generation disclosed herein occur in real time during processing of each query and response, without requiring offline batch processing or pre-computation of security decisions. Each query received through the client engagement layer is classified, routed, executed, and validated dynamically as it is processed, such that security and compliance constraints are evaluated and enforced based on the specific content, context, and policy conditions applicable to that interaction at the time of processing.

The deployed digital twin instances referenced throughout this disclosure are generated, stored, licensed, and managed using the digital twin creation and deployment architecture disclosed in [19/252,577], which is incorporated herein by reference. That architecture provides mechanisms for collecting data pertaining to a subject, processing the data into models representing the subject's knowledge, behaviors, and communication patterns, generating a digital twin from those models, storing the digital twin in a database, licensing the digital twin for deployment, and monitoring deployed instances for compliance with established scope of knowledge and privacy requirements. The present disclosure extends that architecture by introducing a runtime security and compliance enforcement layer that governs query processing, model execution, and response generation associated with deployed digital twin instances during their operational use. Accordingly, the mechanisms disclosed herein operate after digital twin instances have been generated and deployed, and do not alter the processes by which digital twins are initially created or trained.

The parent application discloses compliance monitoring and privacy management mechanisms that govern data collection, knowledge extraction, twin generation, and instance- level operation, including enforcement of privacy boundaries and knowledge scope constraints across deployed digital twin instances. The security and compliance enforcement layer disclosed herein operates at a finer granularity, enforcing security, privacy, and regulatory constraints at the level of individual queries and responses processed by deployed digital twin instances. In particular, the mechanisms disclosed herein address technical challenges not addressed by instance-level compliance controls, including dynamic classification of individual queries to derive per-interaction security constraints, construction of least-privilege prompt packages that limit contextual data provided to artificial intelligence models on a per-query basis, policy-driven routing of individual interactions between private and external model execution environments, and validation of artificial intelligence-generated candidate outputs prior to release. These per- interaction enforcement mechanisms complement the instance-level compliance controls disclosed in the parent application by addressing risks arising from dynamic query processing, hybrid model execution architectures, and emergent content generated by artificial intelligence models during runtime operation.

Although the embodiments described herein are presented in the context of a digital twinning platform in which deployed artificial intelligence agent instances are configured as digital twins of specific subjects, the runtime security and compliance enforcement architecture disclosed herein is applicable to artificial intelligence agent platforms more broadly. The technical challenges addressed by the disclosed system-including dynamic classification of queries to derive per-interaction security constraints, construction of least-privilege prompt packages, policy-driven routing between private and external model execution environments, post-generation compliance enforcement on candidate outputs, and generation of tamper-evident audit artifacts-arise in any artificial intelligence platform in which an artificial intelligence agent processes queries using contextual data, invokes one or more artificial intelligence models, and generates responses that may implicate security, privacy, or regulatory concerns. Such platforms include agentic artificial intelligence platforms, retrieval-augmented generation systems, multi-agent orchestration frameworks, enterprise artificial intelligence assistants, customer-facing conversational artificial intelligence systems, and artificial intelligence-driven decision support and advisory systems. In embodiments involving such platforms, a deployed artificial intelligence agent instance need not represent or emulate a specific real-world subject and need not be generated through a digital twin creation process. Rather, the deployed artificial intelligence agent instance may be any artificial intelligence system configured to receive queries, access contextual data from one or more data sources, process queries using one or more artificial intelligence models, and generate outputs for delivery to users, applications, or other agents. The security classification engine, secure routing and context construction subsystem, artificial intelligence execution layer, response compliance layer, audit and evidence subsystem, and secure learning and feedback integration subsystem disclosed herein each operate on the same principles and perform the same functions whether the underlying artificial intelligence agent instance is a digital twin or a non-digital-twin artificial intelligence agent. Accordingly, when the term "deployed digital twin instance" is used herein to describe the subject of query processing and response generation, a person of ordinary skill in the art will understand that the disclosed mechanisms are equally applicable to any deployed artificial intelligence agent instance, and references to digital twin-specific attributes such as licensing parameters or knowledge boundaries derived from a digital twin creation process may be understood as references to analogous configuration parameters, authorized knowledge domains, permitted operational scopes, or deployment constraints applicable to any deployed artificial intelligence agent instance.

In an embodiment, a client engagement layer serves as an entry point through which a query associated with a deployed digital twin instance is received. The query may be received through a natural language interface, an application programming interface, a messaging interface, or an agent-to-agent communication mechanism. Along with query content, contextual metadata is captured, such as, for example, a user identifier, a tenant identifier, a session identifier, jurisdictional information, authorization attributes, device characteristics, or interaction context. The client engagement layer does not directly invoke an artificial intelligence model. Instead, the query and associated metadata are forwarded for security evaluation prior to any contextual data retrieval or model execution.

In an embodiment, the client engagement layer receives queries directed to a deployed artificial intelligence agent instance that is not configured as a digital twin of a specific subject. The deployed artificial intelligence agent instance may be, for example, an enterprise artificial intelligence assistant configured to respond to employee queries using organizational knowledge, a customer-facing conversational artificial intelligence agent configured to provide information or perform transactions, an autonomous artificial intelligence agent configured to execute tasks within a defined operational scope, or an artificial intelligence agent operating within a multi- agent orchestration platform. As with queries directed to digital twin instances, the client engagement layer captures contextual metadata associated with the query, including a user identifier, a tenant identifier, a session identifier, jurisdictional information, authorization attributes, and interaction context, and forwards the query and associated metadata to the security classification engine for evaluation prior to any contextual data retrieval or model execution. The security and compliance enforcement pipeline that follows-including security classification, prompt package construction, model routing, response compliance analysis, and audit generation-operates identically regardless of whether the query is directed to a digital twin instance or to a non-digital-twin artificial intelligence agent instance.

In an embodiment, a security classification engine analyzes received query content and associated metadata to determine applicable security, privacy, and regulatory constraints. Classification may consider factors such as query semantics, identity and role of a requesting user, characteristics of a digital twin instance including licensing parameters and knowledge boundaries, regulatory domains applicable to an interaction, and policy sets associated with a tenant or deployment environment. Classification may be performed using rule-based analysis expressed in a policy language, machine-learned classifiers trained to identify sensitive or regulated information categories, or combinations thereof. For example, a machine-learned classifier may identify a sensitive information category within a query, and an output of that classifier may be validated or overridden using explicit policy rules.

In an embodiment, the security classification engine is configured to classify queries directed to deployed artificial intelligence agent instances that are not configured as digital twins. In such embodiments, classification may consider factors such as query semantics, identity and role of a requesting user, characteristics of the deployed artificial intelligence agent instance including configuration parameters, authorized knowledge domains, permitted operational scope, tool access permissions, and deployment constraints, regulatory domains applicable to the interaction, and policy sets associated with a tenant or deployment environment. Classification techniques including rule-based analysis, machine-learned classifiers, and token-level or span- level inspection operate in the same manner as described with respect to digital twin instances. The security decision record generated by the security classification engine specifies the same categories of constraints-sensitivity labels, permitted data sources, permitted model classes, required data transformations, and required compliance actions-regardless of whether the query is associated with a digital twin instance or a non-digital-twin artificial intelligence agent instance. In an embodiment, policy sets consumed by the security classification engine may include policies specific to a category or type of artificial intelligence agent, such that different enforcement behaviors may be applied depending on whether the agent is a digital twin of a financial advisor, an enterprise knowledge assistant, a customer service agent, or an autonomous task execution agent, while the classification engine itself and the structure of the security decision record remain consistent across all agent types.

As a result of classification, a security decision record is generated. The security decision record is a structured data object that governs downstream processing of a query. In an embodiment, a security decision record may specify one or more sensitivity labels, permitted data sources, permitted classes of artificial intelligence models, required data transformations, required logging or audit actions, or required enforcement behaviors. The security decision record supports least-privilege operation by explicitly authorizing what data may be accessed, how that data may be used, and where execution may occur. When classification confidence does not meet a predefined threshold or when policy rules indicate ambiguity, a more restrictive enforcement posture may be selected, such as blocking execution, requiring human review, or routing execution exclusively to private infrastructure.

In an embodiment, a secure routing and context construction subsystem receives a security decision record and identifies candidate contextual data elements associated with a deployed digital twin instance. Candidate contextual data may originate from structured data stores, unstructured document repositories, knowledge graphs, vector stores, historical interaction data, or other information maintained by a platform. Each candidate contextual data element is evaluated independently against constraints specified by the security decision record. Data elements that are not authorized are excluded from further processing.

Authorized contextual data elements are assembled into a prompt package according to a least-privilege construction process. The prompt package includes only information required to enable an artificial intelligence model to generate a response consistent with the query. In an embodiment, prompt package structure may vary depending on model type and may include natural language instructions, structured fields, or references to contextual data. When required by a security decision record, sanitization or transformation techniques are applied prior to inclusion. Such techniques may include, for example, redaction of sensitive values, replacement with tokens, summarization to remove identifying details, feature extraction, or conversion to abstract representations. In an embodiment, deterministic tokenization may be used such that replaced values can be resolved within secure infrastructure after model execution. In an embodiment, prompt package assembly may proceed incrementally, with intermediate evaluation steps that re-apply security classification as additional contextual data elements are identified during retrieval. In such an incremental construction process, the prompt package is iteratively refined and sensitivity constraints are adaptively enforced during assembly rather than solely prior to assembly, thereby reducing the risk that sensitive or restricted data is inadvertently included in the prompt package.

In an embodiment, the secure routing and context construction subsystem constructs prompt packages for queries directed to deployed artificial intelligence agent instances that are not configured as digital twins. In such embodiments, candidate contextual data elements may be associated with the deployed artificial intelligence agent instance rather than with a digital twin instance, and may include organizational knowledge bases, policy document repositories, product catalogs, operational databases, customer records, technical documentation, code repositories, external data feeds, or other data sources configured for access by the artificial intelligence agent. Each candidate contextual data element is evaluated against the security decision record in the same manner as described with respect to digital twin instances, and data elements that are not authorized are excluded from the prompt package. The least-privilege construction process, sanitization and transformation techniques, incremental assembly with intermediate reclassification, and deterministic tokenization mechanisms disclosed herein operate identically regardless of whether the contextual data is associated with a digital twin instance or a non-digital-twin artificial intelligence agent instance. In an embodiment, the secure routing and context construction subsystem determines execution routing for queries directed to non-digital-twin artificial intelligence agent instances based on constraints specified in the security decision record, including routing to a private model execution environment when the security decision record indicates the presence of sensitive or regulated information, routing to an external model execution environment when authorized and after application of required sanitization, or routing to a hybrid combination thereof. Routing decisions are enforced programmatically based on the security decision record and are not dependent on the type of artificial intelligence agent instance to which the query is directed.

In an embodiment, cryptographic protections are applied to prompt packages and intermediate artifacts. Such protections may include encryption in transit, encryption at rest, and use of tenant-specific encryption keys managed by a key management system or hardware security component. Cryptographic protections may further include envelope encryption techniques in which data encryption keys are themselves encrypted using tenant-specific master keys, and secure key rotation policies that periodically replace encryption keys in accordance with organizational or regulatory requirements. a compliant prompt package cannot be constructed, fail-closed behavior may be invoked, such as blocking execution or requiring human approval. In an embodiment, prompt packages may be stored in encrypted form within secure infrastructure for audit, replay, or forensic purposes, enabling subsequent reconstruction or verification of inputs provided to artificial intelligence models during processing of a query.

In an embodiment, an artificial intelligence execution layer processes a prompt package under constraints specified by a security decision record. Execution may occur within a private model execution environment hosted within secure infrastructure, an external model execution environment accessed over a network, or a hybrid combination thereof. A private model execution environment may be isolated using containerization, virtual machines, or process-level isolation and may have restricted or disabled network egress to prevent unauthorized data transmission. Private models within such an environment may include language models, predictive models, simulation models, or other artificial intelligence models configured to operate on data associated with digital twins. An external model execution environment may be accessed only when authorized and may receive only sanitized prompt packages.

In an embodiment, the artificial intelligence execution layer processes prompt packages associated with queries directed to deployed artificial intelligence agent instances that are not configured as digital twins. Private models within a private model execution environment may include language models, predictive models, reasoning models, task execution models, code generation models, or other artificial intelligence models configured to operate on data associated with any deployed artificial intelligence agent instance, including agentic artificial intelligence platforms, enterprise artificial intelligence assistants, multi-agent orchestration systems, and artificial intelligence-driven decision support systems. External model execution environments may similarly process prompt packages associated with non-digital-twin artificial intelligence agent instances, subject to the same authorization and sanitization requirements specified by the security decision record. Execution constraints derived from the security decision record, including restrictions on model selection, limits on execution time or resource usage, and prohibitions on network communication, are applied uniformly regardless of whether the prompt package is associated with a digital twin instance or a non-digital-twin artificial intelligence agent instance. In an embodiment, the hybrid execution strategy in which a private model execution environment processes sensitive contextual data to generate an intermediate representation and an external model execution environment generates a candidate output based on that intermediate representation is equally applicable to non-digital-twin artificial intelligence agent instances. For example, in an enterprise artificial intelligence assistant deployment, a private model may process proprietary business data or confidential employee records to generate an abstracted intermediate representation, and an external model may perform language generation or reasoning based on the abstracted representation without receiving access to the underlying sensitive data. Candidate outputs generated by the artificial intelligence execution layer are forwarded to the response compliance layer for evaluation regardless of the type of artificial intelligence agent instance involved.

In an embodiment, a hybrid execution strategy is employed in which a private model execution environment processes contextual data associated with a sensitivity label to generate an intermediate representation, and an external model execution environment generates a candidate output based on that intermediate representation. Intermediate representations may be abstracted to prevent disclosure of sensitive information while enabling higher-level synthesis or language generation by an external model. Execution constraints derived from a security decision record may include restrictions on model selection, limits on execution time or resource usage, or prohibitions on network communication. One or more candidate outputs may be generated during execution. Candidate outputs are not released directly to a user.

In an embodiment, a response compliance layer analyzes candidate outputs prior to release. Analysis may detect disclosures of sensitive information, violations of policy constraints, regulated advice beyond authorized scope, or inconsistencies with authorized contextual data. Detection techniques may include rule-based pattern matching, machine-learned classifiers, token-level or span-level inspection, or comparison against known sensitive placeholders. Analysis may further include evaluating whether a candidate output references or reflects data elements that were not authorized for inclusion in the prompt package, thereby detecting cases in which an artificial intelligence model has introduced content derived from sources outside the authorized context.

When a violation is detected, enforcement actions are applied. Enforcement actions may include, for example, redacting portions of a candidate output, rewriting a candidate output to remove restricted content, regenerating a candidate output using an alternative model or configuration, escalating a candidate output for human review, or blocking output delivery entirely. Enforcement actions may be applied iteratively until a compliant output is produced or blocking criteria are met. Only a candidate output that satisfies applicable security, privacy, and regulatory requirements is released for delivery through a client engagement layer.

In an embodiment, the response compliance layer analyzes candidate outputs generated in response to queries directed to deployed artificial intelligence agent instances that are not configured as digital twins. The analysis techniques disclosed herein, including rule-based pattern matching, machine-learned classifiers, token-level or span-level inspection, and comparison against known sensitive placeholders, are applied to candidate outputs regardless of the type of artificial intelligence agent instance that generated or is associated with the query. Enforcement actions including redaction, rewriting, regeneration, escalation for human review, and blocking are selected and applied based on the security decision record and applicable policy rules, and are not dependent on whether the underlying artificial intelligence agent instance is a digital twin. In an embodiment, the response compliance layer may apply enforcement actions specific to the operational context of a non-digital-twin artificial intelligence agent instance. For example, in a multi-agent orchestration platform, the response compliance layer may evaluate candidate outputs generated by one artificial intelligence agent before such outputs are provided as inputs to another artificial intelligence agent within the orchestration, thereby enforcing security and compliance constraints at inter-agent communication boundaries in addition to at the point of delivery to a requesting user. In an embodiment involving an enterprise artificial intelligence assistant, the response compliance layer may detect candidate outputs that reference proprietary data elements, trade secrets, or internal strategic information that was not authorized for disclosure in the applicable context, and may apply redaction or rewriting enforcement actions to prevent unauthorized disclosure. The controlled release mechanism, whereby only candidate outputs satisfying applicable security, privacy, and regulatory requirements are released for delivery, operates identically for digital twin instances and non-digital-twin artificial intelligence agent instances.

In an embodiment, the audit and evidence subsystem generates audit artifacts associated with processing of queries directed to deployed artificial intelligence agent instances that are not configured as digital twins. Audit artifacts generated for such queries capture the same categories of information as described with respect to digital twin instances, including security decision records, routing decisions, identifiers of models invoked, policy version identifiers, enforcement actions applied, and released outputs, together with metadata describing the user, tenant, session, jurisdiction, and processing time. Audit artifacts may be stored in a tamper-evident data store and cryptographically bound to policy versions and model versions in the same manner regardless of the type of artificial intelligence agent instance involved. In an embodiment, audit artifacts generated for queries directed to non-digital-twin artificial intelligence agent instances may include additional metadata specific to the operational context of the agent, such as identifiers of tools or external services invoked by an agentic artificial intelligence platform, identifiers of other artificial intelligence agents involved in a multi-agent orchestration, or task execution records associated with an autonomous artificial intelligence agent. Correlation of audit artifacts using shared identifiers such as query identifiers, session identifiers, or agent instance identifiers enables reconstruction of the operational lifecycle of a query processed by any deployed artificial intelligence agent instance, supporting supervisory review, forensic analysis, and regulatory reporting for non-digital-twin deployments with the same rigor as for digital twin deployments.

In an embodiment, an audit and evidence subsystem generates records associated with processing of each query. Audit artifacts may include security decision records, routing decisions, identifiers of models invoked, policy version identifiers, enforcement actions applied, and released outputs. Audit artifacts may include metadata describing a user, tenant, session, jurisdiction, and processing time. In an embodiment, audit artifacts may include references to contextual data sources accessed during processing without storing the underlying sensitive data itself, thereby supporting traceability and reconstruction of processing decisions while limiting exposure of sensitive content within audit records. Artifacts may be stored in a tamper-evident data store using cryptographic hash chaining, digital signatures, or append-only storage techniques. Audit artifacts may be cryptographically bound to policy versions and model versions to support later verification, supervisory review, forensic analysis, or regulatory reporting.

In an embodiment, a secure learning and feedback integration subsystem manages learning updates derived from interactions with deployed digital twin instances. Learned information may be received from user feedback, interaction signals, supervisory review outcomes, or automated evaluation processes. Learning updates may include refinement of model prompts, updates to local knowledge representations, adjustment of inference parameters based on observed interactions, or generation of aggregated features or summaries derived from interaction data. Learned information is placed in a quarantine state and evaluated against applicable security and compliance constraints, including reclassification and application of de- identification or anonymization techniques. Promotion of learned information for use in subsequent query processing occurs only when predefined requirements such as aggregation thresholds or anonymity criteria are satisfied. Learning operations generate audit artifacts that record evaluation, promotion, or rejection decisions.

In an embodiment, the secure learning and feedback integration subsystem manages learning updates derived from interactions with deployed artificial intelligence agent instances that are not configured as digital twins. In such embodiments, learned information may be received from user feedback, interaction signals, supervisory review outcomes, or automated evaluation processes associated with any deployed artificial intelligence agent instance, including agentic artificial intelligence platforms, enterprise artificial intelligence assistants, multi-agent orchestration platforms, and artificial intelligence-driven decision support systems. The quarantine, security and compliance evaluation, de-identification, and controlled promotion mechanisms disclosed herein operate in the same manner regardless of whether the learned information is derived from interactions with a digital twin instance or a non-digital-twin artificial intelligence agent instance. Learning updates derived from interactions with non- digital-twin artificial intelligence agent instances may include refinement of agent instructions or system prompts, updates to organizational knowledge bases or retrieval indexes, adjustment of inference parameters, tool usage policies, or agent behavioral constraints based on observed interactions, or generation of aggregated features or summaries derived from interaction data. Promotion of such learned information for use in subsequent query processing is subject to the same predefined requirements, including aggregation thresholds and anonymity criteria, as described with respect to digital twin instances.

In an embodiment, additional defensive mechanisms may be employed to enhance security. Such mechanisms may include embedding controlled canary values or honeytokens within contextual data to detect unauthorized disclosure, wherein detection of such values in generated outputs or external communications may trigger containment actions such as blocking output delivery, alerting security personnel, or initiating forensic review monitoring and restricting network egress from private execution environments, and analyzing classification and routing outcomes over time to detect anomalous behavior or policy drift. These mechanisms further reduce risk of data leakage while enabling adaptive improvement of artificial intelligence behavior within enforced security and compliance boundaries.

In an embodiment, the security classification engine may be invoked at multiple stages during processing of a query. An initial classification may be performed based on query content and metadata received from the client engagement layer. A subsequent classification may be performed after candidate contextual data elements are identified during retrieval, enabling evaluation of whether retrieved data elements introduce additional sensitivity considerations. A further classification may be performed prior to response release to confirm that a candidate output remains consistent with applicable constraints. This iterative classification approach enables adaptive security enforcement that responds to information discovered at each processing stage rather than relying solely on initial query analysis.

In an embodiment, the artificial intelligence execution layer may generate multiple candidate outputs in response to a prompt package. Multiple candidate outputs may be generated using different models, different model configurations, or different prompt formulations. Generation of multiple candidates enables the response compliance layer to evaluate alternatives and select a candidate output that satisfies compliance requirements. When a first candidate output is determined to violate a constraint, an alternative candidate output may be selected without requiring complete regeneration. The decision to generate multiple candidate outputs may be controlled by the security decision record or by policy rules associated with a query classification.

In an embodiment, a candidate output that satisfies applicable security, privacy, and regulatory requirements and is released for delivery may be tagged with compliance metadata. Compliance metadata may indicate a compliance status, one or more policy version identifiers applied during processing, sensitivity labels associated with the query or response, or usage constraints applicable to downstream handling. Compliance metadata may be consumed by downstream systems or client applications to enforce additional controls, display appropriate notices to users, or support subsequent audit or review processes.

In an embodiment, feedback signals used for learning are validated prior to incorporation into learned information. Validation may include verifying that a feedback source has authority to provide feedback for a particular digital twin instance, tenant, or knowledge domain. Validation may further include applying consistency checks to determine whether feedback conflicts with previously validated information or with security and compliance policies. Feedback that cannot be validated or that conflicts with applicable policies may be excluded from learning or may trigger escalation for additional review. By validating feedback prior to use, the system reduces risk that unauthorized or inconsistent information is incorporated into digital twin knowledge representations.

In an embodiment, feedback signals used for learning are validated prior to incorporation into learned information associated with a deployed artificial intelligence agent instance that is not configured as a digital twin. Validation may include verifying that a feedback source has authority to provide feedback for the particular artificial intelligence agent instance, tenant, or knowledge domain, and applying consistency checks to determine whether feedback conflicts with previously validated information, agent configuration parameters, or security and compliance policies applicable to the agent. Feedback that cannot be validated or that conflicts with applicable policies may be excluded from learning or may trigger escalation for additional review. By validating feedback prior to use regardless of agent type, the system reduces risk that unauthorized or inconsistent information is incorporated into artificial intelligence agent knowledge representations, whether those representations are associated with digital twin instances or non-digital-twin artificial intelligence agent instances.

In an embodiment, the system may be configured for operation in a financial services environment. In such a configuration, the security classification engine may identify queries or contextual data implicating material non-public information, confidential account information, investment advice subject to suitability requirements, or trading-sensitive data. Policy rules may specify that queries classified with a sensitivity label indicating material non-public information must be routed exclusively to a private model execution environment. Policy rules may further specify that candidate outputs containing investment recommendations must be logged at an enhanced audit level and may require supervisory review prior to release. Audit artifacts generated during processing may be retained and structured to support regulatory examinations.

In an embodiment, the system may be configured for operation in a healthcare environment. In such a configuration, the security classification engine may identify queries or contextual data implicating protected health information or patient-identifying data. Policy rules may require that contextual data elements containing protected health information be sanitized using de-identification techniques prior to inclusion in a prompt package routed to an external model execution environment. Policy rules may further specify retention periods for audit artifacts that satisfy healthcare governance requirements applicable to a deployment jurisdiction.

In an embodiment, the system may be configured for operation in an enterprise environment for protection of proprietary information and trade secrets. In such a configuration, the security classification engine may identify queries or contextual data implicating confidential business information, proprietary processes, or internal strategic data. Policy rules may restrict use of such information to private model execution environments. Hybrid execution strategies may be employed in which a private model generates an abstracted intermediate representation from proprietary data, and an external model performs language generation based on the abstracted representation without receiving access to underlying confidential content.

In an embodiment, the artificial intelligence execution layer implements isolation mechanisms to contain faults or policy violations. If an external model returns a candidate output that violates security or compliance constraints, the violation is contained within the response compliance layer without affecting other execution environments, other tenants, or other concurrent query processing operations. Isolation mechanisms may include sandboxing of execution processes, enforcement of resource limits, and process-level separation between execution environments. By isolating execution and containing faults, the system prevents failures or policy violations in one component from propagating to other components or affecting system-wide operation.

In an embodiment, the security classification engine may generate explanatory metadata associated with a security decision record. Explanatory metadata may indicate which policy rules, machine-learned classifier outputs, or input features contributed to a particular classification outcome. Explanatory metadata may be included in audit artifacts and may be used for debugging classification behavior, conducting compliance reviews, responding to regulatory inquiries, or refining policy rules based on observed classification patterns.

Through integration of runtime classification, constrained context construction, policy- driven routing, post-generation compliance enforcement, secure learning, and auditable recordkeeping, the disclosed system enables secure and compliant operation of artificialintelligence-driven digital twin platforms across diverse deployment environments.

The disclosed system provides technical improvements to computer and network systems by enabling secure and compliant artificial intelligence execution at runtime. The system improves data security by preventing unauthorized data exposure during artificial intelligence processing through runtime classification and least-privilege context construction. The system improves network control by enforcing policy-driven routing and egress restrictions that prevent transmission of sensitive data outside secure infrastructure. The system improves system reliability by isolating execution environments and containing faults such that failures or policy violations in one component do not propagate to other components or affect system-wide operation. By integrating classification, routing, compliance enforcement, and audit generation into a unified runtime architecture, the platform enables hybrid artificial intelligence deployments in environments where conventional artificial intelligence systems are unsuitable due to security or regulatory constraints.

In an embodiment, the system architecture may support horizontal scaling of classification, routing, and execution components to accommodate varying query volumes and workloads across deployment environments. The system may be integrated with existing enterprise security infrastructure, including identity providers, access management systems, security information and event management platforms, or other organizational security components, to leverage established security controls and policies during runtime enforcement of security and compliance constraints.

In a non-limiting use case example, a wealth management firm deploys digital twin instances of senior financial advisors to provide guidance to clients across multiple branch offices. A client at a regional branch submits a query through a natural language interface asking the digital twin for recommendations regarding rebalancing a retirement portfolio in light of recent market conditions. The query is received by the client engagement layer along with metadata including the client's user identifier, the tenant identifier associated with the branch office, a session identifier, and jurisdictional information indicating the client is located in a jurisdiction with specific investment advice regulations.

The security classification engine analyzes the query content and metadata. The engine identifies that the query requests investment advice, which implicates regulatory constraints regarding suitability and disclosure. The engine further identifies that responding to the query may require access to the client's account holdings, which constitute confidential financial information, and may require reference to recent market data and internal research maintained by the firm. Based on this analysis and applicable policy rules associated with the tenant, the security classification engine generates a security decision record. The security decision record specifies a sensitivity label indicating presence of confidential account information and regulated investment advice, permits retrieval of contextual data from the client's account data store and the firm's internal research repository, specifies that execution must occur within a private model execution environment, requires that any candidate output be logged at an enhanced audit level, and requires supervisory review for responses containing specific investment recommendations.

The secure routing and context construction subsystem receives the security decision record and identifies candidate contextual data elements. The subsystem retrieves the client's current portfolio holdings from an account data store, relevant market commentary from the firm's research repository, and historical interaction data reflecting prior conversations between the client and the digital twin instance. Each retrieved data element is evaluated against the security decision record. A research document containing material non-public information regarding a pending acquisition is identified and excluded from the prompt package because the security decision record does not authorize inclusion of material non-public information for this query. Authorized contextual data elements are assembled into a prompt package using a least- privilege construction process.

Because the security decision record specifies that execution must occur within a private model execution environment, the secure routing and context construction subsystem routes the prompt package to a private model hosted within the firm's secure infrastructure. The private model execution environment is isolated using containerization and has network egress disabled to prevent transmission of confidential account information outside secure infrastructure.

The artificial intelligence model within the private execution environment processes the prompt package and generates a candidate output. The candidate output includes an analysis of the client's current portfolio allocation, observations regarding recent market trends, and a suggestion to consider increasing allocation to fixed income instruments given the client's stated retirement timeline.

The response compliance layer receives the candidate output along with the security decision record. The layer analyzes the candidate output to detect potential violations. The layer determines that the suggestion regarding fixed income allocation constitutes a specific investment recommendation subject to supervisory review under applicable policy rules. The layer also scans the candidate output for inadvertent disclosure of confidential information and confirms that no material non-public information or data from unauthorized sources appears in the response.

Because the security decision record requires supervisory review for specific investment recommendations, the response compliance layer escalates the candidate output for human review rather than releasing it directly. A compliance supervisor at the firm receives a notification and reviews the candidate output within a supervisory interface. The supervisor confirms that the recommendation is consistent with the client's investment profile and suitability requirements and approves the response for release.

Upon approval, the response compliance layer releases the candidate output to the client engagement layer for delivery to the client. The released output is tagged with compliance metadata indicating that supervisory review was completed and identifying the policy version applied during processing.

Throughout this processing, the audit and evidence subsystem generates audit artifacts at each stage. Audit artifacts capture the security decision record, the routing decision specifying private model execution, the identifier of the model invoked, the policy version applied, the escalation for supervisory review, the supervisor's approval, and the final released output. Audit artifacts are stored in a tamper-evident data store using cryptographic hash chaining and are cryptographically bound to the policy version and model version in effect during processing. These artifacts are retained in accordance with regulatory requirements applicable to investment advice and are available for subsequent compliance audits or regulatory examinations.

Several days later, the client provides feedback indicating that the portfolio rebalancing suggestion was helpful. This feedback is received by the secure learning and feedback integration subsystem. The feedback is placed in a quarantine state and evaluated for security and compliance implications. The subsystem verifies that the feedback source is the authenticated client associated with the original interaction and applies consistency checks to confirm the feedback does not conflict with existing knowledge or policies. Because the feedback relates to a specific client interaction involving confidential account information, the subsystem determines that the feedback may be incorporated into instance-level learning associated with that client's digital twin interactions but may not be promoted to shared models without de-identification. The feedback is stored in a tenant-isolated data store. A learning audit artifact is generated recording the feedback source, the quarantine evaluation outcome, and the decision to permit instance-level incorporation without broader promotion.

The foregoing use case example illustrates operation of the disclosed system in a wealth management context and is non-limiting in nature. The example demonstrates how the security classification engine, secure routing and context construction subsystem, artificial intelligence execution layer, response compliance layer, audit and evidence subsystem, and secure learning and feedback integration subsystem operate cooperatively to enforce security, privacy, and regulatory constraints during query processing, model execution, response generation, and learning updates. The disclosed system is applicable to numerous other use cases that are not explicitly described herein. For example, the system may be deployed in a healthcare environment where digital twin instances of medical specialists respond to clinical queries while enforcing constraints related to protected health information and patient privacy. The system may be deployed in a legal services environment where digital twin instances of attorneys provide guidance on contractual matters while preventing disclosure of privileged client communications and enforcing jurisdictional limitations on legal advice. The system may be deployed in an enterprise environment where digital twin instances of technical experts provide internal consultation while protecting trade secrets and proprietary business information from transmission to external model execution environments. The system may be deployed in an insurance environment where digital twin instances of underwriters evaluate risk inquiries while enforcing constraints on use of protected personal information and compliance with jurisdiction- specific insurance regulations. The system may be deployed in a government or public sector environment where digital twin instances of policy specialists respond to citizen inquiries while enforcing classification constraints and preventing unauthorized disclosure of sensitive government information. Each such deployment may employ different sensitivity labels, policy rules, routing constraints, and compliance actions configured for the applicable regulatory and operational context, while utilizing the same underlying system architecture and runtime enforcement mechanisms disclosed herein.

In addition to deployments involving digital twin instances, the disclosed system may be deployed in environments in which the artificial intelligence agent instances are not configured as digital twins of specific subjects. In a non-limiting use case example, an enterprise deploys an agentic artificial intelligence assistant configured to respond to employee queries by retrieving information from internal knowledge bases, human resources policy documents, financial records, and external data sources. The artificial intelligence assistant is not a digital twin of any specific individual but is an autonomous artificial intelligence agent configured to operate within a defined knowledge scope and policy framework. When an employee submits a query requesting guidance on a proposed vendor contract, the client engagement layer receives the query together with metadata identifying the employee, the employee's organizational unit, and the applicable jurisdiction. The security classification engine classifies the query and determines that responding may require access to confidential procurement data and internal pricing information. The security decision record specifies that the query must be routed to a private model execution environment and that candidate outputs must be evaluated for inadvertent disclosure of trade secret or competitively sensitive information. The secure routing and context construction subsystem retrieves authorized contextual data from the enterprise knowledge base, excludes documents classified above the employee's access level, and constructs a least-privilege prompt package. The artificial intelligence execution layer processes the prompt package within the private model execution environment. The response compliance layer evaluates the candidate output and detects a reference to an internal pricing benchmark that is restricted to senior procurement personnel. The response compliance layer applies a redaction enforcement action to remove the restricted reference and releases the compliant output to the employee. Audit artifacts capturing the security decision record, routing decision, enforcement action, and released output are stored in the tamper-evident data store. This use case illustrates that the security classification engine, secure routing and context construction subsystem, artificial intelligence execution layer, response compliance layer, and audit and evidence subsystem operate in the same manner for non-digital-twin artificial intelligence agent instances as for digital twin instances.

In a further non-limiting use case example, an organization deploys a multi-agent orchestration platform in which multiple artificial intelligence agents collaborate to complete complex analytical tasks. A first artificial intelligence agent is configured to retrieve and summarize financial market data from external sources, and a second artificial intelligence agent is configured to apply the summarized data to internal portfolio models containing confidential client information. Neither agent is a digital twin of a specific individual. When a portfolio analyst initiates an analysis request, the security classification engine classifies the request and generates a security decision record that permits the first agent to access external market data using an external model execution environment, but requires the second agent to operate exclusively within a private model execution environment due to the presence of confidential client portfolio data. The response compliance layer evaluates candidate outputs generated by each agent, including outputs passed between agents within the orchestration, to enforce security and compliance constraints at inter-agent communication boundaries. Audit artifacts are generated for each agent interaction within the orchestration, enabling reconstruction of the complete multi-agent processing lifecycle. This use case illustrates application of the disclosed security and compliance enforcement architecture to multi-agent orchestration platforms in which multiple non-digital-twin artificial intelligence agents operate cooperatively under differentiated security constraints.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features.

Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, "artificial intelligence execution layer" refers to one or more computing environments configured to execute artificial intelligence models under constraints specified by a security decision record, including private, external, or hybrid execution environments.

As used herein, "audit artifact" refers to a structured record generated during processing of a query or learning operation that captures security, compliance, routing, execution, or enforcement information for evidentiary, supervisory, or forensic purposes.

As used herein, "candidate output" refers to an output generated by an artificial intelligence model in response to a prompt package that has not yet been released to a requesting user and is subject to compliance evaluation.

As used herein, "classification confidence" refers to one or more confidence measures associated with a classification outcome, including scores, thresholds, or certainty indicators derived from rule-based logic, machine-learned classifiers, or combinations thereof.

As used herein, "client engagement layer" refers to one or more interfaces through which queries and associated metadata are received from users, applications, or automated agents without directly invoking artificial intelligence models.

As used herein, "compliance constraint" refers to a rule, policy, regulatory requirement, or governance condition that restricts processing, routing, output generation, or learning within the system.

As used herein, "controlled promotion" refers to a process by which learned information is conditionally approved for use beyond an originating interaction or instance based on predefined policy criteria, aggregation thresholds, or anonymity requirements.

As used herein, "contextual data" refers to information retrieved or identified for potential inclusion in a prompt package, including structured records, unstructured documents, knowledge graph elements, vector embeddings, or historical interaction data associated with a digital twin.

As used herein, "digital twin" refers to a deployed artificial intelligence-driven representation of a subject, entity, system, or knowledge domain configured to interact with users through query processing and response generation.

As used herein, "enforcement action" refers to an operation applied to a candidate output or processing flow in response to a detected security, privacy, or regulatory concern, including redaction, rewriting, regeneration, escalation, blocking, or restriction.

As used herein, "fail-closed mode" refers to an enforcement posture in which processing privileges are reduced or removed under conditions of uncertainty, preventing continued operation unless explicitly permitted by policy.

As used herein, "feedback" refers to explicit or implicit signals derived from interactions with a digital twin, including user input, supervisory review outcomes, or interaction-derived metrics.

As used herein, "hybrid execution" refers to an execution strategy in which multiple artificial intelligence execution environments are used in combination, such that sensitive information is processed in a private environment and an abstracted representation is processed in an external environment.

As used herein, "implicit interaction-derived signals" refers to non-explicit feedback inferred from interaction behavior, usage patterns, or response handling associated with a digital twin interaction.

As used herein, "learning quarantine" refers to a controlled isolation state in which learned information is held pending evaluation against security, privacy, and compliance constraints prior to any promotion for use.

As used herein, "learned information" refers to information derived from feedback or interactions that may influence subsequent classification, context construction, or artificial intelligence behavior, including aggregated data, features, summaries, metadata, or parameter adjustments.

As used herein, "least-privilege" refers to a principle under which only the minimum data, execution capabilities, and resources required to perform an authorized operation are permitted.

As used herein, "policy rule" refers to a machine-interpretable condition, constraint, or directive used to govern classification, routing, execution, compliance enforcement, or learning operations.

As used herein, "prompt package" refers to a structured input provided to an artificial intelligence model that includes authorized contextual data and instructions assembled in accordance with a security decision record.

As used herein, "restricted response" refers to an output indicating that a requested operation cannot be completed under applicable security, privacy, or regulatory constraints.

As used herein, "security classification engine" refers to a system component configured to analyze queries, metadata, or contextual data to derive security, privacy, and regulatory constraints applicable to processing.

As used herein, "security decision record" refers to a structured data object generated by classification that specifies constraints governing routing, context construction, model execution, compliance enforcement, and audit behavior.

As used herein, "sensitivity label" refers to an indicator associated with information that identifies a category of security, privacy, or regulatory concern applicable to that information.

As used herein, "tenant-isolated data store" refers to a storage environment configured to restrict access to data on a per-tenant or per-instance basis in accordance with security boundaries.

As used herein, "tamper-evident data store" refers to a storage mechanism configured to make unauthorized modification of stored records detectable through cryptographic or structural techniques.

### Conceptual Architecture of a Digital Twinning Platform

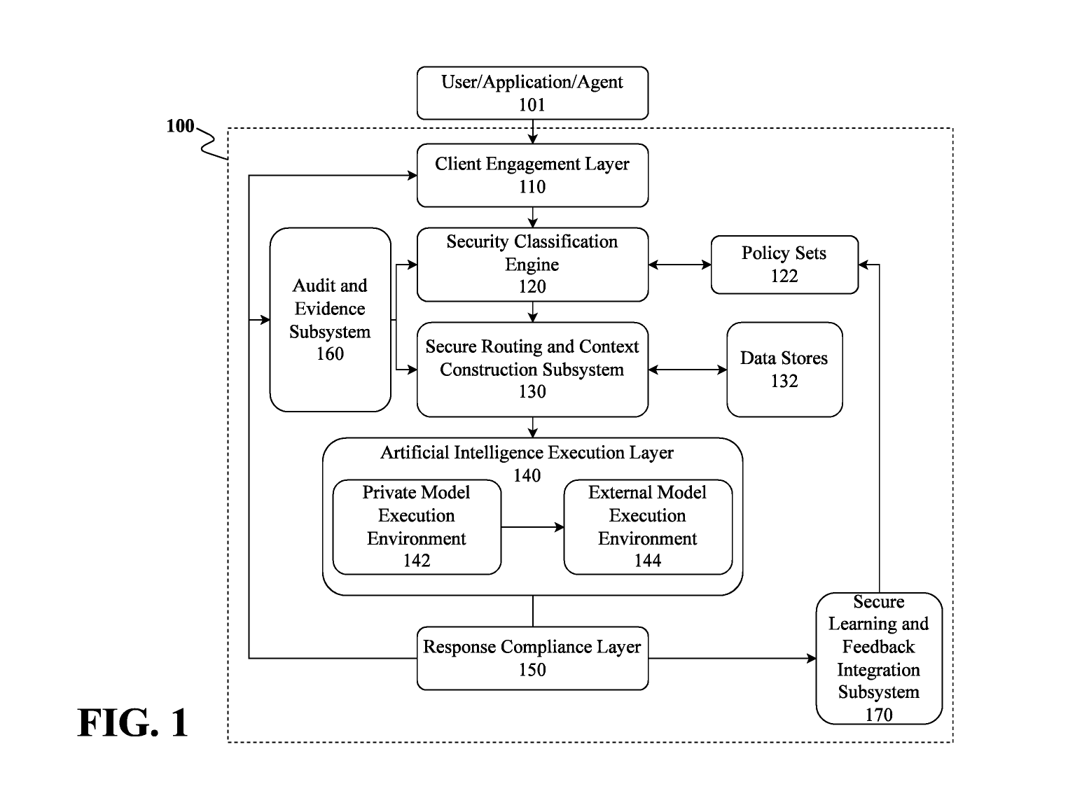

FIG. 1 is a block diagram illustrating exemplary architecture of a digital twinning platform with a security and compliance enforcement layer 100, in an embodiment. The platform 100 is configured to receive queries from users, applications, or agents 101 and to process those queries through a series of coordinated components that derive security controls, constrain execution, and validate artificial intelligence operations associated with deployed digital twin instances. The architecture integrates security and compliance enforcement into runtime operation of artificial intelligence systems rather than relying solely on static access controls or preconfigured permissions.

In an embodiment, a deployed digital twin instance referenced herein may be generated, stored, licensed, and managed using a digital twin creation and deployment architecture, such as an architecture disclosed in an incorporated parent application.

A client engagement layer 110 serves as an entry point through which queries directed to deployed digital twin instances are received together with metadata such as user identifiers, tenant identifiers, session identifiers, and jurisdictional information. The client engagement layer 110 captures this contextual metadata and forwards the query and metadata to downstream components without directly invoking any artificial intelligence model or retrieving contextual data. Queries and associated metadata flow from the client engagement layer 110 to a security classification engine 120 for evaluation prior to any contextual data access or model execution.

A security classification engine 120 is configured to derive applicable security, privacy, and regulatory constraints from received query content and associated metadata. The security classification engine 120 may evaluate factors including query semantics, identity and role attributes associated with a requesting user, characteristics of a deployed digital twin instance, applicable regulatory domains, and one or more policy sets 122 associated with a tenant or deployment environment. Policy sets 122 may be versioned and selected at runtime based on deployment context. Classification may be performed using rule-based analysis expressed in a policy language, machine-learned classifiers, or combinations thereof. As an output of classification, the security classification engine 120 generates a security decision record that specifies parameters such as sensitivity labels, permitted data sources, permitted model classes, required data transformations, required logging levels, and required compliance actions. The security decision record is provided to a secure routing and context construction subsystem 130 as a control structure governing downstream processing.

A secure routing and context construction subsystem 130 receives the security decision record and identifies candidate contextual data elements from data stores 132 associated with a deployed digital twin instance. Candidate contextual data may originate from structured data stores, unstructured document repositories, knowledge graphs, vector stores, or historical interaction data. Each candidate contextual data element is independently evaluated against constraints specified in the security decision record, and data elements that are not explicitly authorized are excluded from further processing. Authorized contextual data elements are assembled into a prompt package according to a least-privilege construction process that includes only information required to enable an artificial intelligence model to generate a response consistent with the query. When required by the security decision record, sanitization or transformation techniques such as redaction, deterministic tokenization, summarization, or feature extraction may be applied prior to inclusion. Based on parameters specified in the security decision record, the secure routing and context construction subsystem 130 determines an execution route and forwards the prompt package to an artificial intelligence execution layer 140.

An artificial intelligence execution layer 140 executes model inference within execution environments constrained by parameters specified in the security decision record. The execution layer 140 may comprise a private model execution environment 142 hosted within secure infrastructure and an external model execution environment 144 accessed over a network. A private model execution environment 142 may be isolated using containerization, virtual machines, or process-level separation and may enforce restricted or disabled network egress to prevent unauthorized data transmission. An external model execution environment 144 may be accessed only when authorized by the security decision record and may receive only sanitized prompt packages that exclude restricted data elements. In some configurations, a hybrid execution strategy may be employed in which the private model execution environment 142 processes contextual data associated with a sensitivity label to generate an intermediate representation, such as an abstracted feature set or summary, and the external model execution environment 144 generates a candidate output based on the intermediate representation without access to underlying sensitive data. One or more candidate outputs generated by the execution layer 140 flow to a response compliance layer 150.

A response compliance layer 150 is configured to evaluate candidate outputs against policy-defined security, privacy, and regulatory constraints prior to release. Detection techniques may include rule-based pattern matching, machine-learned classifiers, token-level or span-level inspection, or comparison against known sensitive placeholders or disallowed content categories. When a violation or potential violation is detected, the response compliance layer 150 may apply one or more enforcement actions such as redacting portions of an output, rewriting an output to remove restricted content, regenerating an output using an alternative model or execution configuration, escalating an output for human review, or blocking output delivery. Only a candidate output that satisfies applicable requirements specified by the security decision record is released to the client engagement layer 110 for delivery to users, applications, or agents 101.

An audit and evidence subsystem 160 receives audit artifacts generated during processing of queries across the platform 100. Audit artifacts may include security decision records, routing decisions, identifiers of models invoked, policy version identifiers, enforcement actions applied, and released outputs. The audit and evidence subsystem 160 may store audit artifacts in a tamper-evident data store using techniques such as cryptographic hash chaining, digital signatures, or append-only storage. Audit artifacts may be correlated using unique identifiers associated with a query, session, or digital twin instance to enable reconstruction of an operational lifecycle for supervisory review, forensic analysis, or regulatory reporting.

A secure learning and feedback integration subsystem 170 receives learned information derived from interactions with deployed digital twin instances. Feedback may originate from the client engagement layer 110 as explicit user feedback or from the response compliance layer 150 as supervisory review outcomes. Learned information received by the subsystem 170 is placed in a quarantine state and evaluated against applicable security and compliance constraints, including reclassification and application of de-identification or anonymization techniques. Promotion of learned information for use in subsequent query processing occurs only when predefined requirements such as aggregation thresholds, anonymity criteria, or policy approval conditions are satisfied. Promoted learning may be provided to one or more components, such as the security classification engine 120 or contextual data stores 132, to support adaptive improvement of artificial intelligence behavior within enforced security and compliance boundaries.

In an embodiment, data flows through the platform 100 in an ordered sequence of processing stages governed by the security decision record generated during classification. A query received from users, applications, or agents 101 enters the platform 100 through the client engagement layer 110, which captures associated metadata and forwards the query and metadata to the security classification engine 120. The security classification engine 120 evaluates the query against applicable policy sets 122 and generates a security decision record that is provided to the secure routing and context construction subsystem 130. The secure routing and context construction subsystem 130 retrieves candidate contextual data from data stores 132, excludes unauthorized data elements, applies required sanitization or transformation operations, assembles a prompt package, and routes the prompt package to the artificial intelligence execution layer 140 based on constraints specified in the security decision record. The execution layer 140 processes the prompt package within the private model execution environment 142, the external model execution environment 144, or a hybrid combination thereof, and generates one or more candidate outputs that are forwarded to the response compliance layer 150. The response compliance layer 150 evaluates the candidate outputs, applies enforcement actions when violations are detected, and releases a compliant output back to the client engagement layer 110 for delivery to users, applications, or agents 101. Throughout this processing, audit artifacts are generated and provided to the audit and evidence subsystem 160, and feedback derived from interactions may be provided to the secure learning and feedback integration subsystem 170 for quarantine evaluation and controlled promotion to improve subsequent query processing.

In an embodiment, the platform architecture illustrated in FIG. 1 is applicable to artificial intelligence agent platforms in which the deployed artificial intelligence agent instances are not configured as digital twins. In such embodiments, the platform 100 receives queries from users, applications, or agents 101 directed to any deployed artificial intelligence agent instance, and processes those queries through the same sequence of security classification, context construction, routing, execution, compliance enforcement, and audit generation stages. The client engagement layer 110, security classification engine 120, policy sets 122, secure routing and context construction subsystem 130, data stores 132, artificial intelligence execution layer 140 including private model execution environment 142 and external model execution environment 144, response compliance layer 150, audit and evidence subsystem 160, and secure learning and feedback integration subsystem 170 each operate as described with respect to FIG. 1 regardless of whether the deployed artificial intelligence agent instance is a digital twin or a non-digital-twin artificial intelligence agent.

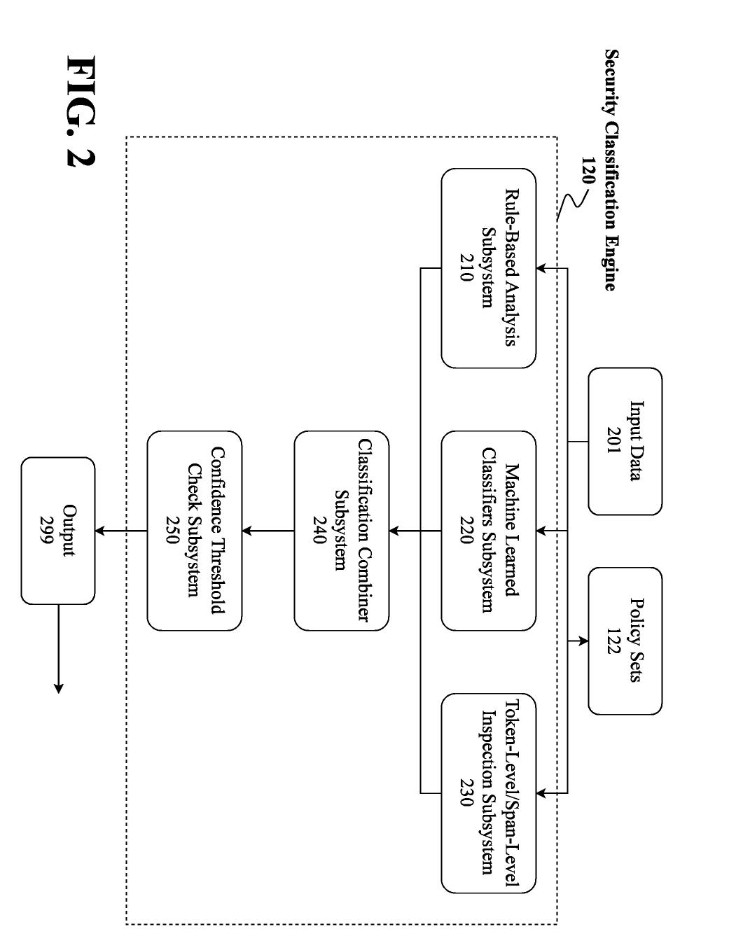

FIG. 2 is a block diagram illustrating a security classification engine 120, in an embodiment. The security classification engine 120 receives input data 201 and policy sets 122, processes the inputs through a series of coordinated classification subsystems, and generates output data 299 that governs downstream execution, routing, and enforcement behavior within the platform.

Input data 201 comprises query content, contextual metadata, and candidate contextual data elements associated with a query directed to a deployed digital twin instance. Query content may include natural language text, structured parameters, or other request data. Contextual metadata may include user identifiers, tenant identifiers, session identifiers, jurisdictional information, user roles, and device characteristics. Candidate contextual data elements may include documents, knowledge graph entities, embeddings, or other data proposed or pre- identified for potential inclusion from data stores associated with the deployed digital twin instance. Policy sets 122 comprise tenant-specific policies, regulatory rules, governance constraints, and policy version information applicable to classification and enforcement.

A rule-based analysis subsystem 210 is configured to apply predefined conditions expressed in a policy language to the input data 201. The rule-based analysis subsystem 210 may apply explicit policy rules associated with a tenant, deployment environment, or regulatory regime to derive security, privacy, or regulatory constraints applicable to a query. A machine- learned classifier subsystem 220 applies one or more trained classification models to the input data 201 to identify sensitive information categories or regulated content types. The machine- learned classifier subsystem 220 may generate candidate sensitivity labels based on features extracted from query content, contextual metadata, or candidate contextual data elements.

A token-level and span-level inspection subsystem 230 analyzes granular portions of the input data 201 to detect sensitive values, patterns, or content segments that may implicate security or compliance constraints. The inspection subsystem 230 may identify specific tokens or spans within query content or candidate contextual data elements that correspond to protected information categories, regulated phrases, or policy-restricted data types. A classification combiner subsystem 240 receives outputs from the rule-based analysis subsystem 210, the machine-learned classifier subsystem 220, and the token-level and span-level inspection subsystem 230. The classification combiner subsystem 240 reconciles, validates, and consolidates classification outputs, including validating candidate labels generated by machine- learned classifiers against explicit policy rules and resolving conflicts or ambiguities among classification results, to produce a consolidated classification result.

A confidence threshold check subsystem 250 is configured to compare one or more confidence metrics associated with the consolidated classification result against a predefined threshold. Confidence metrics may include classifier confidence scores, rule match certainty indicators, or aggregated confidence measures derived from multiple classification techniques. When classification confidence meets or exceeds the predefined threshold, the confidence threshold check subsystem 250 permits generation of output data 299 based on the consolidated classification result. When classification confidence falls below the threshold, the confidence threshold check subsystem 250 may trigger a fail-closed mode in which further processing is restricted, execution is blocked, execution is routed exclusively to a private model execution environment, or the query is escalated for human review.

Output data 299 comprises a security decision record and associated explanatory metadata generated by the security classification engine 120. The security decision record may specify sensitivity labels indicating categories of information implicated by the query, permitted data sources from which contextual information may be retrieved, permitted model classes that may be invoked, required data transformations to be applied prior to model execution, required compliance actions such as enhanced logging or supervisory review, and policy version identifiers associated with the classification. Explanatory metadata may indicate which policy rules were triggered, which classifier outputs contributed to the classification outcome, or which input features influenced confidence determination. Output data 299 is provided to downstream subsystems including a secure routing and context construction subsystem 130, a response compliance layer 150, and an audit and evidence subsystem 160.

In an embodiment, data flows through the security classification engine 120 from input to output through a combination of parallel and sequential processing stages. Input data 201 and policy sets 122 enter the security classification engine 120 and are provided to the rule-based analysis subsystem 210, the machine-learned classifier subsystem 220, and the token-level and span-level inspection subsystem 230. The rule-based analysis subsystem 210 applies policy rules from policy sets 122 to generate rule-derived classification outputs. The machine-learned classifier subsystem 220 processes the input data 201 to generate candidate sensitivity labels based on trained classification models. The token-level and span-level inspection subsystem 230 analyzes granular elements of the input data 201 to identify specific tokens or spans corresponding to protected or regulated information categories. Classification outputs from the rule-based analysis subsystem 210, the machine-learned classifier subsystem 220, and the token- level and span-level inspection subsystem 230 flow to the classification combiner subsystem 240, which reconciles and consolidates the outputs into a unified classification result. The consolidated classification result flows from the classification combiner subsystem 240 to the confidence threshold check subsystem 250, which determines whether classification confidence satisfies the predefined threshold. When the threshold is met, output data 299 comprising the security decision record and explanatory metadata is generated and provided to downstream subsystems including the secure routing and context construction subsystem 130, the response compliance layer 150, and the audit and evidence subsystem 160. When classification confidence falls below the threshold, the confidence threshold check subsystem 250 triggers a fail-closed mode that restricts or blocks further processing.

In some embodiments, the security classification engine 120 may be invoked multiple times during processing of a query, including prior to contextual data retrieval, after candidate contextual data elements are identified, and prior to response release, enabling adaptive and iterative enforcement of security and compliance constraints as additional information becomes available.

In an embodiment, the security classification engine 120 illustrated in FIG. 2 is applicable to classification of queries directed to deployed artificial intelligence agent instances that are not configured as digital twins. In such embodiments, input data 201 comprises query content, contextual metadata, and candidate contextual data elements associated with a query directed to any deployed artificial intelligence agent instance. The rule-based analysis subsystem 210, machine-learned classifier subsystem 220, token-level and span-level inspection subsystem 230, classification combiner subsystem 240, and confidence threshold check subsystem 250 each operate as described with respect to FIG. 2, and the security decision record generated as output data 299 specifies the same categories of constraints regardless of the type of artificial intelligence agent instance involved.

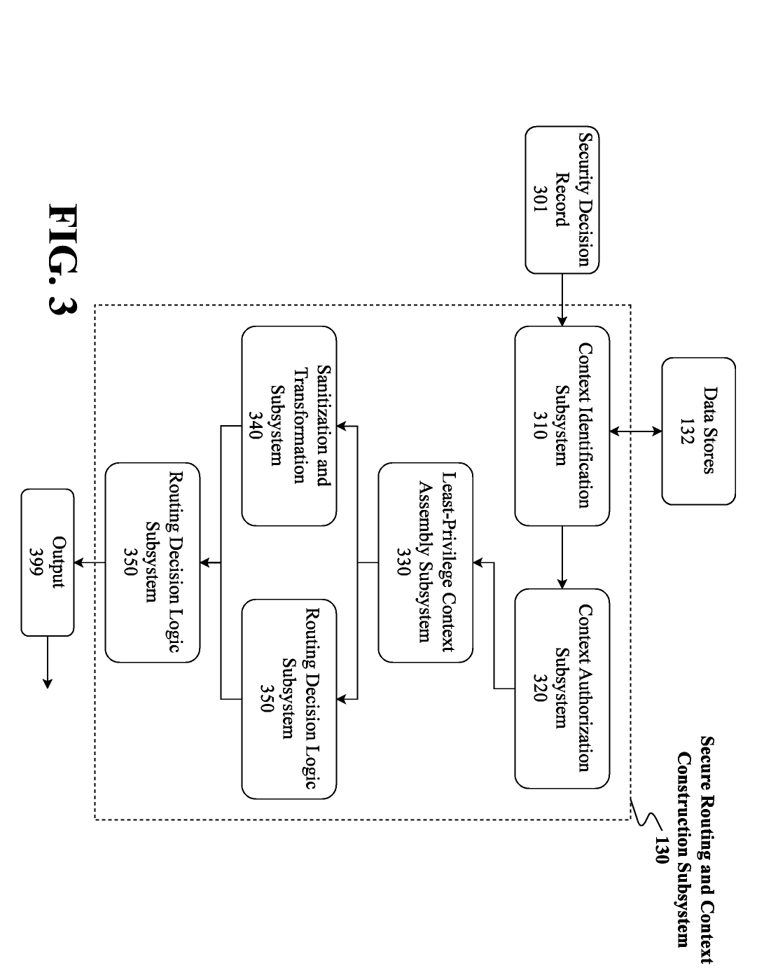

FIG. 3 is a block diagram illustrating a secure routing and context construction subsystem 130, in an embodiment. The secure routing and context construction subsystem 130 receives a security decision record 301 from a security classification engine 120 and accesses data stores 132 associated with a deployed digital twin instance within a controlled platform boundary. The subsystem 130 processes these inputs through a series of coordinated functional subsystems to construct a prompt package and select an execution environment, generating output data 399 that is provided to an artificial intelligence execution layer 140 under policy-driven constraints.

A context identification subsystem 310 is configured to locate or select candidate contextual data elements from data stores 132 associated with the deployed digital twin instance. Candidate contextual data may originate from structured data stores, unstructured document repositories, knowledge graphs, vector stores, or historical interaction data maintained by the platform. The context identification subsystem 310 retrieves candidate data elements for evaluation within the subsystem 130 without releasing such data elements to an artificial intelligence execution environment or to external systems.

A context authorization subsystem 320 evaluates each candidate contextual data element identified by the context identification subsystem 310 against constraints specified in the security decision record 301. Evaluation criteria may include sensitivity labels associated with the data element, access permissions, tenant boundaries, jurisdictional constraints, and regulatory applicability. Candidate contextual data elements that are not explicitly authorized by the security decision record 301 are excluded from further processing and are not included in a prompt package.

A least-privilege context assembly subsystem 330 assembles authorized contextual data elements into a prompt package according to a least-privilege construction process. The prompt package includes only information required to enable an artificial intelligence model to generate a response consistent with the query and applicable constraints. The structure of the prompt package may vary depending on the type of model to be invoked and may include natural language instructions, structured data fields, references to contextual documents, or abstracted representations of contextual data.

A sanitization and transformation subsystem 340 enforces sanitization or transformation requirements specified in the security decision record 301 prior to inclusion of contextual data elements in the prompt package. Such techniques may include redaction of sensitive fields, replacement of sensitive values with tokens, summarization of content to remove identifying details, feature extraction, or conversion to abstract representations. In some configurations, deterministic tokenization may be used such that replaced values can be resolved within secure infrastructure after model execution.

A routing decision logic subsystem 350 selects an execution environment for the prompt package based on constraints specified in the security decision record 301. Execution routes may include processing by a private model execution environment hosted within secure infrastructure, processing by an external model execution environment accessed over a network, or a hybrid combination thereof. Routing decisions are enforced programmatically by orchestration logic governed by the security decision record 301 rather than by user preference or static configuration parameters.

A cryptographic protection subsystem 360 enforces cryptographic protections on prompt packages and intermediate artifacts prior to execution and prior to any transmission outside secure infrastructure. Such protections may include encryption in transit, encryption at rest, and use of tenant-specific encryption keys managed by a key management system or hardware security component. The cryptographic protection subsystem 360 receives inputs from the sanitization and transformation subsystem 340 and routing information from the routing decision logic subsystem 350 to apply protections appropriate to the selected execution environment before generating output data 399.

Output data 399 comprises a constructed prompt package with associated routing instructions and applied cryptographic protections. The output data 399 may further include a fail-closed determination when a compliant prompt package cannot be constructed in accordance with the security decision record 301, in which case execution may be blocked, restricted to private infrastructure, or escalated for human approval. Output data 399 is provided to the artificial intelligence execution layer 140 for model execution under enforced constraints.

In an embodiment, data flows through the secure routing and context construction subsystem 130 from inputs to output through a combination of sequential and parallel processing stages governed by the security decision record 301. The security decision record 301 enters the subsystem 130 and constrains operation of downstream functional subsystems. The context identification subsystem 310 accesses data stores 132 and retrieves candidate contextual data elements, which are evaluated by the context authorization subsystem 320 against constraints specified in the security decision record 301. Authorized contextual data elements flow to the least-privilege context assembly subsystem 330, which constructs a prompt package containing only the minimum information required for compliant model execution. From the least-privilege context assembly subsystem 330, processing proceeds to the sanitization and transformation subsystem 340 and the routing decision logic subsystem 350, which operate in coordination under the security decision record 301 to apply required transformations and select an execution environment. Outputs from the sanitization and transformation subsystem 340 and routing decision logic subsystem 350 converge at the cryptographic protection subsystem 360, which enforces encryption and key management protections to generate output data 399. The output data 399, comprising the prompt package, routing instructions, and cryptographic protections, is then provided to the artificial intelligence execution layer 140.

In some embodiments, the secure routing and context construction subsystem 130 may be invoked multiple times during processing of a query, including after additional contextual data elements are identified or when updated constraints are generated by reclassification, enabling adaptive and iterative enforcement of least-privilege context construction and routing decisions.

In an embodiment, the secure routing and context construction subsystem 130 illustrated in FIG. 3 is applicable to construction of prompt packages and determination of execution routing for queries directed to deployed artificial intelligence agent instances that are not configured as digital twins. In such embodiments, data stores 132 may contain contextual data associated with any deployed artificial intelligence agent instance, and the context identification subsystem 310, context authorization subsystem 320, least-privilege context assembly subsystem 330, sanitization and transformation subsystem 340, routing decision logic subsystem 350, and cryptographic protection subsystem 360 each operate as described with respect to FIG. 3 to generate output data 399 under constraints specified by the security decision record 301.

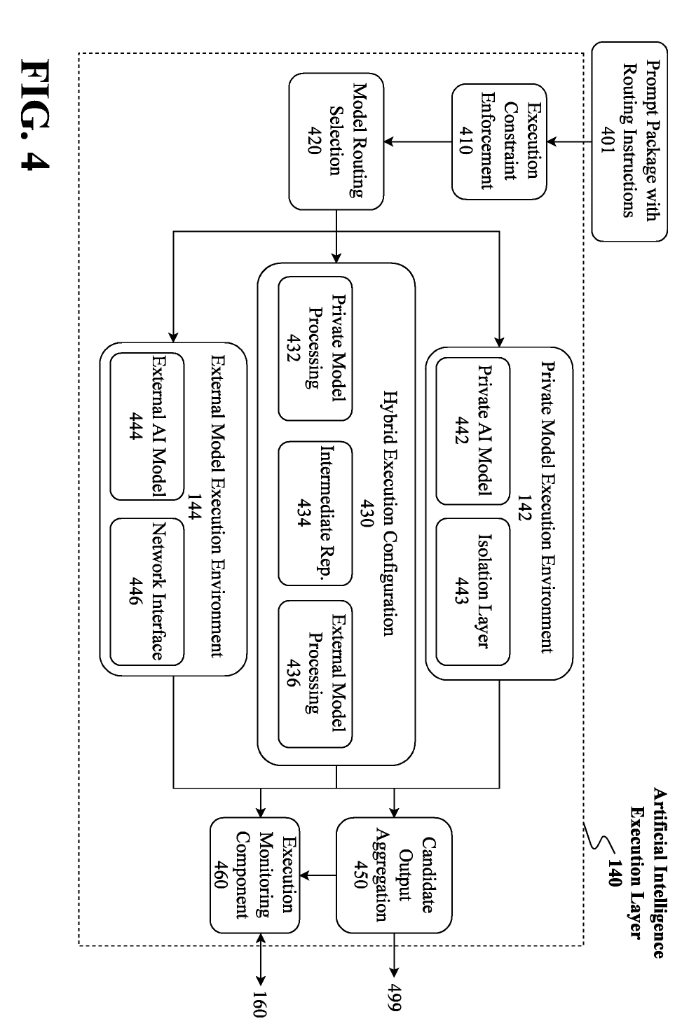

FIG. 4 is a block diagram illustrating exemplary architecture of an artificial intelligence execution layer 140, in an embodiment. An artificial intelligence execution layer 140 receives a prompt package with routing instructions 401 from a secure routing and context construction subsystem 130. The prompt package with routing instructions 401 comprises contextual data elements authorized by a security decision record together with execution parameters specifying applicable constraints and a selected execution route.

An execution constraint enforcement component 410 receives the prompt package with routing instructions 401 and evaluates execution parameters against constraints derived from the security decision record. Such constraints may include, for example, restrictions on permissible model classes, limits on execution time or resource utilization, or prohibitions on network communication. In an embodiment, the execution constraint enforcement component 410 prevents initiation of execution paths that do not satisfy applicable constraints and conditions downstream processing to occur only within authorized execution environments. A model routing selection component 420 receives constrained execution parameters produced by the execution constraint enforcement component 410 and determines an authorized execution configuration based on routing instructions specified in the security decision record.

A model routing selection component 420 selects among multiple execution configurations and coordinates invocation of one or more execution environments without exposing unauthorized contextual data elements or execution capabilities.

In a first execution configuration, processing is directed to a private model execution environment 142. A private model execution environment 142 is hosted within secure infrastructure and may be isolated at a container, virtual machine, or process level. A private AI model 442 within the private model execution environment 142 processes prompt packages that include sensitive or regulated contextual data elements. An isolation layer 443 enforces separation between the private model execution environment 142 and other execution environments or system components. In an embodiment, the private model execution environment 142 enforces restricted or disabled network egress to prevent unauthorized transmission of data outside secure infrastructure. In an embodiment, artificial intelligence models executing within private model execution environment 442 may include models generated through digital twin creation and training processes disclosed in an incorporated parent application. Such models may operate on data associated with a deployed digital twin instance and may be subject to execution constraints derived from a security decision record generated by security classification engine 120.

In a second execution configuration, processing is directed to an external model execution environment 144. The external model execution environment 144 is accessed over a network interface 446 and receives only prompt packages that have been sanitized in accordance with security and compliance requirements specified in the security decision record. An external AI model 444 within the external model execution environment 144 may provide processing capabilities such as higher-level synthesis or language generation. The external model execution environment 144 is prevented from accessing private data stores or contextual repositories beyond information explicitly included in a sanitized prompt package.

In a third execution configuration, processing is directed to a hybrid execution configuration 430 that combines private and external model execution. Within the hybrid execution configuration 430, a private model processing component 432 processes contextual data elements associated with a sensitivity label to generate an intermediate representation 434. The intermediate representation 434 may comprise an abstracted feature set, summary, or other transformed representation that reduces or removes sensitive information while preserving semantic content sufficient for downstream processing. An external model processing component 436 receives the intermediate representation 434 and generates a candidate output based on the abstracted content without access to underlying sensitive data from which the intermediate representation 434 was derived.

Outputs produced by the private model execution environment 142, the external model execution environment 144, or the hybrid execution configuration 430 are provided to a candidate output aggregation component 450. The candidate output aggregation component 450 collects one or more outputs generated under authorized execution configurations and produces one or more candidate outputs 499. Candidate outputs 499 are not delivered directly to a requesting user but are forwarded to a response compliance layer 150 for evaluation prior to release. In some configurations, multiple candidate outputs may be produced using different execution environments, models, or configurations to enable selection of a compliant response by the response compliance layer 150.

An execution monitoring component 460 receives execution event data associated with processing performed within the private model execution environment 142, the external model execution environment 144, and the hybrid execution configuration 430. Execution event data may include, for example, model invocation records, execution duration metrics, resource utilization indicators, and error conditions. In an embodiment, the execution monitoring component 460 further receives metadata associated with candidate outputs aggregated by the candidate output aggregation component 450, including identifiers correlating candidate outputs to execution environments, model instances, and execution events. The execution monitoring component 460 does not evaluate semantic content of candidate outputs but correlates execution and output metadata to support traceability and evidence generation.

The execution monitoring component 460 provides execution event data and correlated output metadata as audit artifacts to an audit and evidence subsystem 160 for tamper-evident storage and subsequent supervisory review, compliance verification, or forensic analysis. In an embodiment, data flows through the artificial intelligence execution layer 140 from input to output through a sequence of constraint enforcement, routing, execution, and output aggregation stages. A prompt package with routing instructions 401 enters the artificial intelligence execution layer 140 from a secure routing and context construction subsystem 130 and is received by an execution constraint enforcement component 410, which evaluates execution parameters against constraints derived from a security decision record and conditions downstream processing to occur only within authorized execution configurations. Constrained execution parameters flow from the execution constraint enforcement component 410 to a model routing selection component 420, which determines an authorized execution configuration and coordinates processing along one of three execution paths based on routing instructions.

When routing specifies private execution, the prompt package flows to a private model execution environment 142 where a private AI model 442 processes the prompt package within an isolation layer 443, and resulting output flows to a candidate output aggregation component 450. When routing specifies external execution, a sanitized prompt package flows to an external model execution environment 144 via a network interface 446 where an external AI model 444 generates output that flows to the candidate output aggregation component 450. When routing specifies hybrid execution, the prompt package flows to a private model processing component 432 within a hybrid execution configuration 430, which generates an intermediate representation 434 that flows to an external model processing component 436, and resulting output flows to the candidate output aggregation component 450.

Throughout execution, an execution monitoring component 460 receives execution event data from each execution environment, including model invocation records, execution duration metrics, and error conditions, and further receives metadata correlating execution events with candidate outputs aggregated by the candidate output aggregation component 450. The execution monitoring component 460 provides execution and correlation metadata as audit artifacts to an audit and evidence subsystem 160, and candidate outputs 499 generated by the candidate output aggregation component 450 are forwarded to a response compliance layer 150 for evaluation prior to any release to a requesting user.

In an embodiment, the artificial intelligence execution layer 140 illustrated in FIG. 4 is applicable to execution of prompt packages associated with queries directed to deployed artificial intelligence agent instances that are not configured as digital twins. In such embodiments, the execution constraint enforcement component 410, model routing selection component 420, private model execution environment 142 including private AI model 442 and isolation layer 443, external model execution environment 144 including external AI model 444 and network interface 446, hybrid execution configuration 430 including private model processing component 432, intermediate representation 434, and external model processing component 436, candidate output aggregation component 450, and execution monitoring component 460 each operate as described with respect to FIG. 4. Candidate outputs 499 generated for queries directed to non- digital-twin artificial intelligence agent instances are forwarded to the response compliance layer 150 for evaluation in the same manner as candidate outputs generated for digital twin instances.

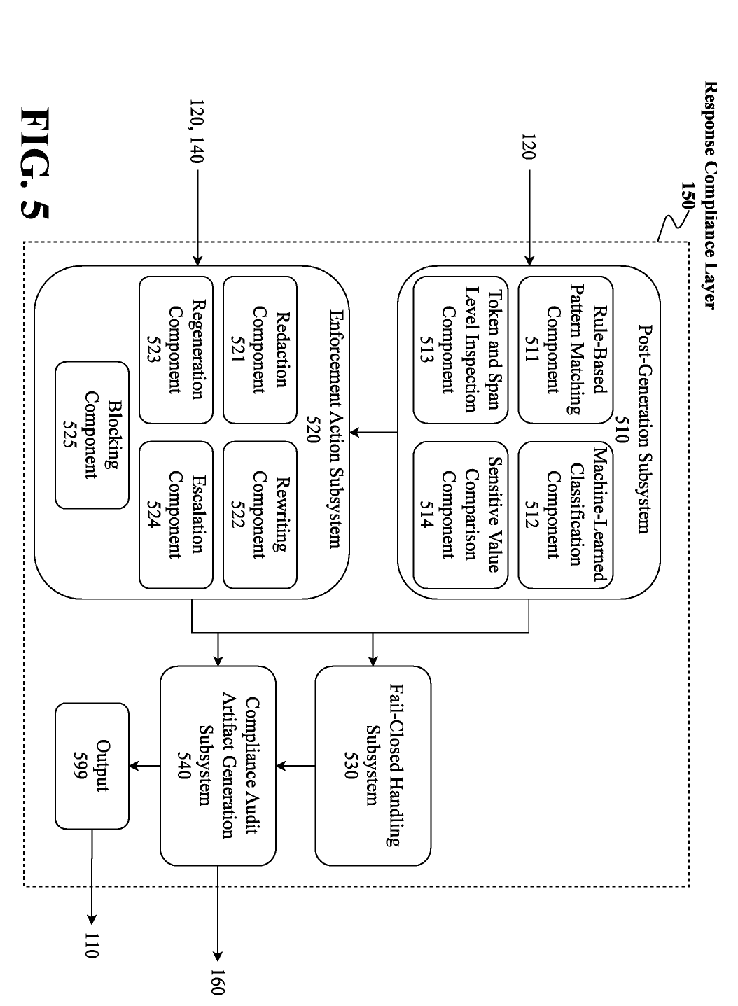

FIG. 5 is a block diagram illustrating exemplary architecture of a response compliance layer 150, in an embodiment. A response compliance layer 150 receives candidate outputs from an artificial intelligence execution layer 140 and receives a security decision record and policy metadata from a security classification engine 120. The response compliance layer 150 operates as a mandatory post-generation control point configured to evaluate candidate outputs against policy-defined security, privacy, and regulatory constraints prior to release and to enforce compliance through controlled remediation or blocking actions.

A post-generation analysis subsystem 510 receives candidate outputs and performs content analysis to identify potential violations of security, privacy, or regulatory constraints specified in the security decision record. The post-generation analysis subsystem 510 comprises a rule-based pattern matching component 511, a machine-learned classification component 512, a token and span-level inspection component 513, and a sensitive value comparison component 514. The rule-based pattern matching component 511 evaluates candidate outputs against predefined patterns expressed in a policy language to identify prohibited content categories or policy-defined violations. The machine-learned classification component 512 applies trained classification models to identify sensitive information disclosures or regulated content types within candidate outputs. The token and span-level inspection component 513 analyzes granular portions of candidate outputs to identify specific tokens or spans corresponding to protected information categories. The sensitive value comparison component 514 compares candidate output content against known sensitive values or placeholders to detect unauthorized inclusion of restricted data elements.

Analysis results generated by the post-generation analysis subsystem 510 are provided to an enforcement action subsystem 520 together with the security decision record and policy metadata. The enforcement action subsystem 520 determines whether remediation is possible and selects one or more enforcement actions in accordance with applicable policy rules and classification outcomes. The enforcement action subsystem 520 may coordinate operation of a redaction component 521, a rewriting component 522, a regeneration component 523, an escalation component 524, or a blocking component 525. The redaction component 521 removes specific portions of a candidate output identified as containing restricted content. The rewriting component 522 modifies a candidate output to remove or generalize restricted content while preserving non-restricted portions. The regeneration component 523 initiates generation of an alternative candidate output using a different model, execution configuration, or constraint set. The escalation component 524 routes a candidate output for human review when policy rules require supervisory approval. The blocking component 525 prevents release of a candidate output when remediation is not permitted or cannot achieve compliance.

When remediation attempts do not result in a compliant output or when policy rules require conservative handling, control flows to a fail-closed handling subsystem 530. The fail- closed handling subsystem 530 manages terminal safety conditions by enforcing restrictive outcomes, including blocking output delivery, requiring explicit human approval, or generating a restricted response indicating that a requested operation cannot be completed. The fail-closed handling subsystem 530 operates as a final enforcement posture rather than a content remediation mechanism.

A compliance audit artifact generation subsystem 540 receives analysis metadata from the post-generation analysis subsystem 510, enforcement metadata from the enforcement action subsystem 520, and disposition information from the fail-closed handling subsystem 530. The compliance audit artifact generation subsystem 540 assembles audit artifacts that record detected violations, policy rules applied, enforcement actions selected, and final release or blocking decisions. Generated audit artifacts are provided to an audit and evidence subsystem 160 for tamper-evident storage and subsequent supervisory review, compliance verification, or forensic analysis.

The response compliance layer 150 releases only candidate outputs that satisfy applicable security, privacy, and regulatory requirements. Released outputs 599 are provided to a client engagement layer 110 for delivery to a requesting user.

In an embodiment, data flows through the response compliance layer 150 from inputs to outputs through a sequence of post-generation analysis, enforcement coordination, fail-closed determination, and audit artifact generation stages. Candidate outputs from the artificial intelligence execution layer 140 enter the response compliance layer 150 and are processed by the post-generation analysis subsystem 510 using rule-based evaluation, machine-learned classification, token and span-level inspection, and sensitive value comparison techniques. Analysis results flow to the enforcement action subsystem 520, which evaluates remediation options in view of the security decision record and policy metadata. When remediation cannot achieve compliance or when required by policy, processing transitions to the fail-closed handling subsystem 530 to enforce restrictive outcomes. Throughout processing, analysis results, enforcement decisions, and final dispositions are provided to the compliance audit artifact generation subsystem 540, which generates audit artifacts for storage by the audit and evidence subsystem 160. Candidate outputs that satisfy applicable requirements are released as released outputs 599 and delivered to a requesting user via the client engagement layer 110.

In an embodiment, the response compliance layer 150 illustrated in FIG. 5 is applicable to evaluation of candidate outputs generated in response to queries directed to deployed artificial intelligence agent instances that are not configured as digital twins. In such embodiments, the post-generation analysis subsystem 510 including the rule-based pattern matching component 511, machine-learned classification component 512, token and span-level inspection component 513, and sensitive value comparison component 514, the enforcement action subsystem 520 including the redaction component 521, rewriting component 522, regeneration component 523, escalation component 524, and blocking component 525, the fail-closed handling subsystem 530, and the compliance audit artifact generation subsystem 540 each operate as described with respect to FIG. 5. Released outputs 599 satisfying applicable requirements are delivered to a requesting user via the client engagement layer 110 regardless of the type of artificial intelligence agent instance involved.

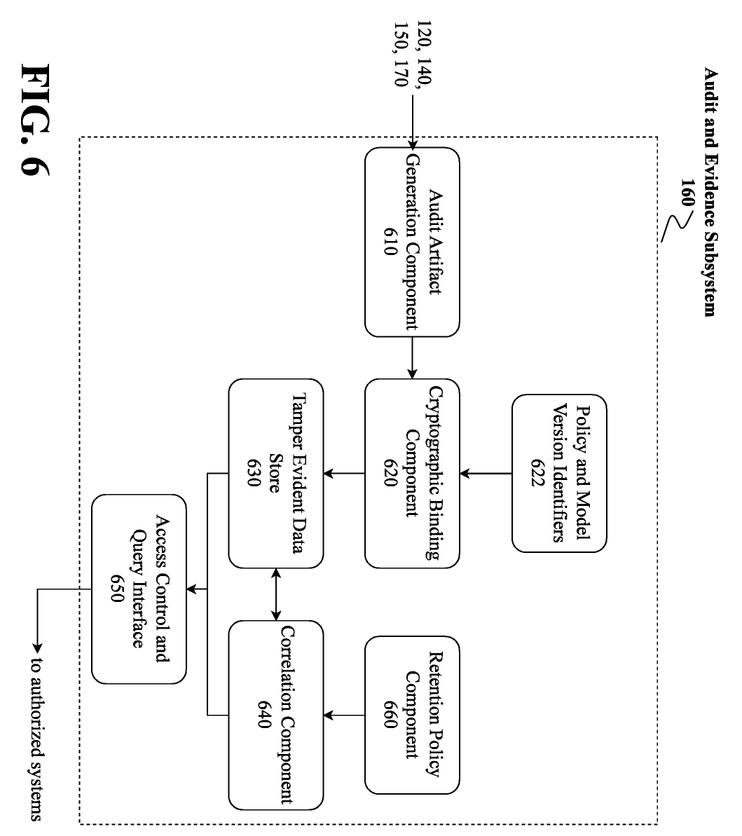

FIG. 6 is a block diagram illustrating exemplary architecture of an audit and evidence subsystem 160, in an embodiment. An audit and evidence subsystem 160 receives audit-relevant data generated during runtime operation of a digital twinning platform and processes that data through a series of coordinated functional components to produce tamper-evident, correlatable, and access-controlled audit artifacts suitable for supervisory review, compliance reporting, and forensic analysis. The audit and evidence subsystem 160 operates as an integrated part of the runtime security and compliance enforcement architecture rather than as a passive logging facility.

An audit artifact generation component 610 receives audit-relevant inputs from a security classification engine 120, an artificial intelligence execution layer 140, a response compliance layer 150, and a secure learning and feedback integration subsystem 170. The audit artifact generation component 610 is configured to transform classification outcomes, execution metadata, enforcement decisions, and response disposition information into structured audit artifacts associated with processing of individual queries or learning events. Audit artifacts may capture, for example, security decision records, routing determinations, identifiers of models invoked, policy version identifiers applied, enforcement actions selected, and released or blocked outputs. Audit artifacts may further include contextual metadata such as user identifiers, tenant identifiers, session identifiers, jurisdictional indicators, and timestamps. The audit artifact generation component 610 outputs structured audit artifacts to downstream components for integrity protection and storage.

A cryptographic binding component 620 receives structured audit artifacts from the audit artifact generation component 610 together with policy and model version identifiers 622 corresponding to configurations in effect during processing. The cryptographic binding component 620 is configured to establish an integrity association between audit artifacts and specific policy versions and model versions, for example by incorporating version identifiers into a cryptographic hash, digital signature, or related binding structure. This association enables later verification that a particular response or enforcement outcome was produced under a particular set of rules and execution configurations. Bound audit artifacts are provided to a tamper-evident data store 630.

A tamper-evident data store 630 is configured to persist audit artifacts using one or more integrity-preserving storage techniques such as cryptographic hash chaining, digital signatures, append-only data structures, or combinations thereof. The tamper-evident data store 630 preserves integrity of stored records over time by rendering unauthorized modification detectable. Audit artifacts stored in the tamper-evident data store 630 may be retained for periods specified by policy, regulation, or organizational governance requirements applicable to a tenant, jurisdiction, or data category.

A correlation component 640 is configured to associate audit artifacts stored in the tamper-evident data store 630 using one or more shared identifiers, such as query identifiers, session identifiers, or digital twin instance identifiers. Through such association, the correlation component 640 enables reconstruction of an operational lifecycle for an interaction, including classification results, context construction decisions, execution events, compliance enforcement actions, and learning outcomes. In some embodiments, correlation metadata generated by the correlation component 640 may itself be stored in the tamper-evident data store 630 to preserve evidentiary integrity.

A retention policy component 660 is configured to enforce lifecycle controls over audit artifacts stored in the tamper-evident data store 630. The retention policy component 660 applies configurable retention rules that may vary by tenant, jurisdiction, regulatory domain, or data category, and manages secure deletion or archival of audit artifacts when applicable retention periods expire. In some embodiments, metadata describing retention decisions or deletion events may be recorded as additional audit artifacts.

An access control and query interface 650 receives correlated audit artifacts from the tamper-evident data store 630 and the correlation component 640 and provides controlled access to such artifacts based on role, authorization attributes, and regulatory constraints. The access control and query interface 650 is configured to support querying, filtering, and exporting of audit artifacts in formats suitable for supervisory review, compliance reporting, or forensic analysis. Access decisions enforced by the access control and query interface 650 may be governed by policy rules associated with a tenant or regulatory environment.

In an embodiment, data flows through the audit and evidence subsystem 160 from input sources to output interfaces through a sequence of artifact generation, integrity binding, tamper- evident storage, correlation, retention management, and controlled access stages. Audit-relevant data originating from a security classification engine 120, an artificial intelligence executionlayer 140, a response compliance layer 150, and a secure learning and feedback integration subsystem 170 enters the audit and evidence subsystem 160 and is processed by the audit artifact generation component 610 to produce structured audit artifacts associated with individual interactions. Structured audit artifacts are then provided to the cryptographic binding component 620, which associates the artifacts with policy and model versions 622 in effect during processing. Bound audit artifacts are persisted in the tamper-evident data store 630. The correlation component 640 associates stored artifacts using shared identifiers to enable reconstruction of interaction lifecycles. The retention policy component 660 enforces applicable retention and deletion rules. Correlated audit artifacts are made available, subject to enforced access controls, through the access control and query interface 650 to one or more authorized recipients, including supervisory users, compliance personnel, forensic analysts, or automated governance and reporting systems operating under applicable policy constraints.

In an embodiment, the audit and evidence subsystem 160 illustrated in FIG. 6 is applicable to generation, storage, and management of audit artifacts associated with queries directed to deployed artificial intelligence agent instances that are not configured as digital twins. In such embodiments, the audit artifact generation component 610, cryptographic binding component 620, tamper-evident data store 630, correlation component 640, access control and query interface 650, and retention policy component 660 each operate as described with respect to FIG. 6. Audit artifacts generated for queries processed by non-digital-twin artificial intelligence agent instances are subject to the same integrity protections, correlation capabilities, retention policies, and access controls as audit artifacts generated for digital twin instances.

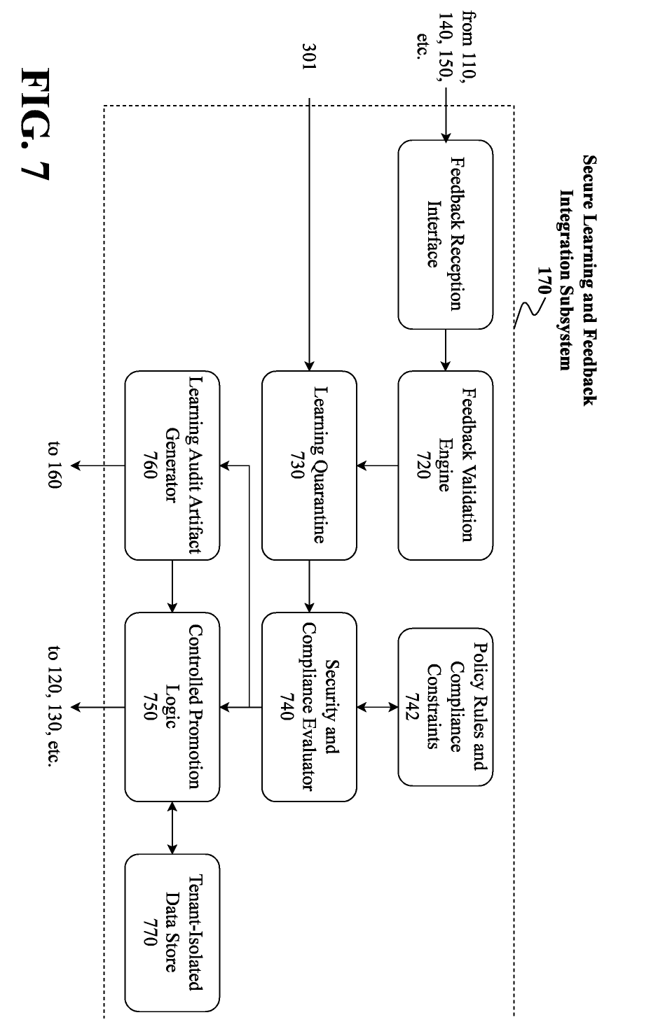

FIG. 7 is a block diagram illustrating exemplary architecture of a secure learning and feedback integration subsystem 170, in an embodiment. A secure learning and feedback integration subsystem 170 receives feedback and interaction-derived data generated during operation of a digital twinning platform and processes that data through a series of coordinated functional elements to enable controlled improvement of artificial intelligence behavior while enforcing security, privacy, and compliance constraints on learned information. The secure learning and feedback integration subsystem 170 operates under policy-driven controls aligned with runtime enforcement mechanisms applied during query processing and response generation.

A feedback reception interface 710 receives input data from a client engagement layer 110 in the form of explicit user feedback, from a response compliance layer 150 in the form of supervisory review outcomes, and from an artificial intelligence execution layer 140 in the form of implicit interaction-derived signals. Implicit interaction-derived signals may include, for example, usage patterns, correction behaviors, response acceptance indicators, or other interaction metrics associated with deployed digital twin instances. The feedback reception interface 710 aggregates feedback originating from these sources and forwards received feedback for validation and evaluation. Feedback received through the feedback reception interface 710 may be associated with specific interactions, digital twin instances, tenants, or knowledge domains.

A feedback validation engine 720 receives feedback from the feedback reception interface 710 and evaluates feedback signals prior to incorporation into learned information. Evaluation may include verifying that a feedback source is authorized to provide feedback for a particular digital twin instance, tenant, or knowledge domain, and applying consistency checks to determine whether feedback conflicts with previously validated information, security decision records, or applicable policy rules. Feedback that cannot be validated or that conflicts with applicable security or compliance constraints may be excluded from further learning processing or may trigger escalation for additional review.

A learning quarantine 730 receives validated feedback from the feedback validation engine 720 and holds derived learned information in a quarantine state prior to any integration into broader system knowledge. The learning quarantine 730 receives a security decision record 301 that specifies applicable security, privacy, and compliance constraints governing evaluation of quarantined information. During the quarantine state, learned information is isolated from use in subsequent query processing pending completion of security and compliance evaluation.

A security and compliance evaluator 740 receives quarantined learned information from the learning quarantine 730 together with policy rules and compliance constraints 742. The security and compliance evaluator 740 evaluates quarantined information for security, privacy, and compliance implications, including determination of whether the information contains sensitive data, regulated content, or policy-restricted elements. Evaluation may include reclassification of learned information and application of transformation techniques such as de- identification, anonymization, aggregation, or abstraction to reduce sensitivity while preserving utility. Learned information that satisfies applicable requirements is forwarded for promotion consideration, while learned information that does not satisfy requirements may be designated as restricted or rejected and stored as non-promoted learning records.

A controlled promotion logic 750 receives compliant learned information from the security and compliance evaluator 740 together with aggregation thresholds, anonymity criteria, and policy conditions governing promotion decisions. The controlled promotion logic 750 applies such criteria to determine whether learned information may be promoted for use in subsequent query processing. Learned information that satisfies promotion requirements may be provided to a security classification engine 120 to support adaptive classification behavior or to data stores 132 to update contextual knowledge associated with deployed digital twin instances. Learned information approved for use only within a specific tenant or digital twin instance, and not for broader promotion, may be stored in a tenant-isolated data store 770. Restricted or rejected learning records may likewise be stored in the tenant-isolated data store 770 to preserve evidentiary separation and prevent unauthorized reuse.

A learning audit artifact generator 760 receives evaluation metadata from the security and compliance evaluator 740 and promotion or rejection metadata from the controlled promotion logic 750. The learning audit artifact generator 760 assembles audit artifacts that record sources of feedback, characteristics of derived learned information, security classifications applied, transformation steps performed, and promotion or rejection outcomes. Generated audit artifacts are provided to an audit and evidence subsystem 160 for tamper-evident storage and for availability to authorized supervisory, compliance, or forensic review processes.

In an embodiment, data flows through the secure learning and feedback integration subsystem 170 from input sources to output destinations through a sequence of reception, validation, quarantine, evaluation, and controlled promotion stages. Feedback originating from a client engagement layer 110, a response compliance layer 150, and an artificial intelligence execution layer 140 enters the subsystem 170 through a feedback reception interface 710 and is aggregated and forwarded to a feedback validation engine 720. Validated feedback is transformed into learned information and placed in a quarantine state by a learning quarantine 730, which receives a security decision record 301 specifying applicable constraints. Quarantined learned information flows to a security and compliance evaluator 740, which evaluates the information using policy rules and compliance constraints 742 and applies reclassification or transformation operations as required. Learned information that satisfies applicable requirements flows to a controlled promotion logic 750, which applies aggregation thresholds and anonymity criteria to determine promotion eligibility. Promoted learned information is provided to a security classification engine 120 or to data stores 132 to support adaptive improvement of artificial intelligence behavior, while instance-level or restricted learning records are stored in a tenant-isolated data store 770. Throughout processing, evaluation and promotion metadata flows to a learning audit artifact generator 760, which generates audit artifacts that are provided to an audit and evidence subsystem 160 for tamper-evident storage and subsequent authorized review.

In an embodiment, learned information promoted through the secure learning and feedback integration mechanisms shown in FIG. 7 may be provided to instance-level learning components or knowledge integration processes disclosed in an incorporated parent application. Promotion decisions governed by the quarantine and evaluation mechanisms disclosed herein may complement instance-level privacy and compliance controls applied during knowledge integration at the platform level.

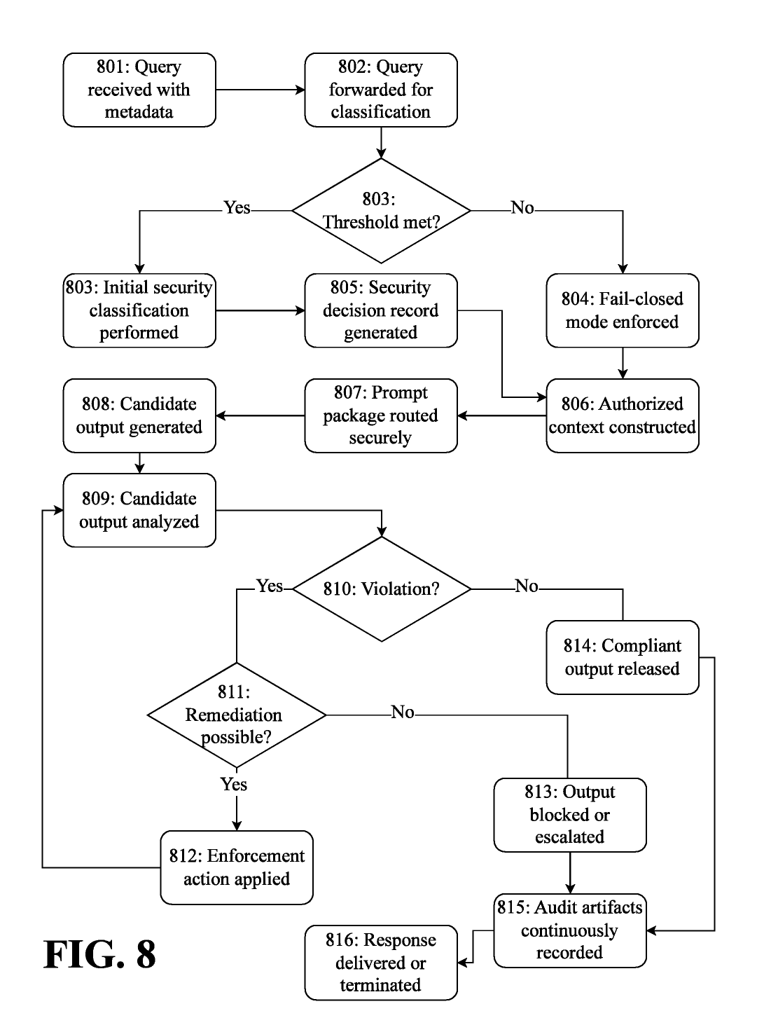

In an embodiment, the secure learning and feedback integration subsystem 170 illustrated in FIG. 7 is applicable to management of learning updates derived from interactions with deployed artificial intelligence agent instances that are not configured as digital twins. In such embodiments, the feedback reception interface 710, feedback validation engine 720, learning quarantine 730, security and compliance evaluator 740, controlled promotion logic 750, learning audit artifact generator 760, and tenant-isolated data store 770 each operate as described with respect to FIG. 7. Learned information derived from interactions with non-digital-twin artificial intelligence agent instances is subject to the same quarantine, evaluation, controlled promotion, and audit generation mechanisms as learned information derived from digital twin interactions. FIG. 8 is a flow diagram illustrating exemplary processing of a query through a security and compliance enforcement layer of a digital twinning platform 100, in an embodiment. The flow diagram depicts processing stages from query reception through response disposition, with security classification, routing control, compliance evaluation, and audit generation performed at multiple stages during processing rather than as a single, isolated operation.

Processing begins when a query directed to a deployed digital twin instance is received at a client engagement layer 110, step 801. The client engagement layer 110 captures metadata associated with the query, including user identifier, tenant identifier, session identifier, and jurisdictional information, and forwards the query and metadata to a security classification engine 120, step 802. The audit and evidence subsystem 160 records receipt of the query and associated metadata as an initial audit artifact.

The security classification engine 120 performs an initial classification of the query and associated metadata to derive applicable security, privacy, and regulatory constraints, step 803. As part of classification, the security classification engine 120 determines whether classification confidence meets a predefined threshold derived from applicable policy rules or configuration parameters. Classification results and confidence metrics are recorded by the audit and evidence subsystem 160.

When classification confidence does not meet the predefined threshold, the security classification engine 120 invokes a fail-closed enforcement mode, step 804. In the fail-closed mode, a security decision record is generated that restricts execution to a private model execution environment 142 or imposes other restrictive handling as specified by policy. The fail-closed decision and associated security decision record are recorded as audit artifacts.

When classification confidence meets the predefined threshold, the security classification engine 120 generates a security decision record specifying sensitivity labels, permitted data sources, permitted model classes, required data transformations, and required compliance actions, step 805. Generation of the security decision record is recorded by the audit and evidence subsystem 160.

A secure routing and context construction subsystem 130 receives the security decision record and identifies candidate contextual data associated with the deployed digital twin instance, step 806. As candidate contextual data elements are identified, the security classification engine 120 may be re-invoked to perform secondary classification of such data to determine whether additional sensitivity considerations apply. Results of secondary classification and context authorization decisions are recorded as audit artifacts. The secure routing and context construction subsystem 130 constructs a prompt package containing only contextual data elements authorized by the security decision record.

Following construction of the prompt package, the secure routing and context construction subsystem 130 routes the prompt package to an execution environment determined by constraints specified in the security decision record, step 807. Routing decisions and applied transformations are recorded by the audit and evidence subsystem 160.

An artificial intelligence execution layer 140 receives the prompt package and generates one or more candidate outputs using an artificial intelligence model within the routed execution environment, step 808. Execution events, including model identifiers and execution context, are recorded as audit artifacts. Generated candidate outputs are forwarded to a response compliance layer 150.

The response compliance layer 150 analyzes a candidate output to detect violations of security, privacy, or regulatory constraints, step 809. As part of analysis, the response compliance layer 150 may invoke the security classification engine 120 to perform output-level classification to determine whether generated content introduces additional sensitivity or policy concerns. Analysis results and any output-level classification determinations are recorded by the audit and evidence subsystem 160.

The response compliance layer 150 determines whether a violation is detected in the candidate output, step 810. When a violation is detected, the response compliance layer 150 determines whether remediation of the candidate output is permitted under applicable policy rules, step 811. Determinations regarding violation detection and remediation eligibility are recorded as audit artifacts.

When remediation is permitted, the response compliance layer 150 applies an enforcement action such as redaction, rewriting, or regeneration to produce a modified candidate output, step 812. The remediated candidate output is returned for further analysis by the response compliance layer 150, step 809, and iterative evaluation continues until a compliant output is produced or further remediation is no longer permitted. Each remediation attempt and associated outcome is recorded by the audit and evidence subsystem 160.

When remediation is not permitted, or when policy rules require conservative handling, the response compliance layer 150 blocks the candidate output or escalates the candidate output for human review, step 813. Blocking or escalation decisions and associated rationale are recorded as audit artifacts.

When no violation is detected in a candidate output, the response compliance layer 150 releases the compliant candidate output for delivery, step 814. Release decisions and compliance metadata associated with the released output are recorded by the audit and evidence subsystem 160.

Throughout processing, the audit and evidence subsystem 160 continuously generates and stores audit artifacts reflecting classification results, routing decisions, execution events, enforcement actions, and final disposition of candidate outputs in a tamper-evident data store, step 815. Audit artifacts generated at different stages are correlated using identifiers associated with the query, session, or deployed digital twin instance.

Processing concludes with delivery of a released response to the user through the client engagement layer 110, step 816, or with an alternative terminal outcome including blocking or escalation, as dictated by applicable security, privacy, and regulatory constraints.

In an embodiment, the end-to-end query processing flow illustrated in FIG. 8 is applicable to processing of queries directed to deployed artificial intelligence agent instances that are not configured as digital twins. In such embodiments, each processing stage from query reception at step 801 through response disposition at step 816, including security classification, context construction, routing, model execution, response compliance analysis, enforcement actions, and audit artifact generation, operates as described with respect to FIG. 8 regardless of the type of artificial intelligence agent instance to which the query is directed.

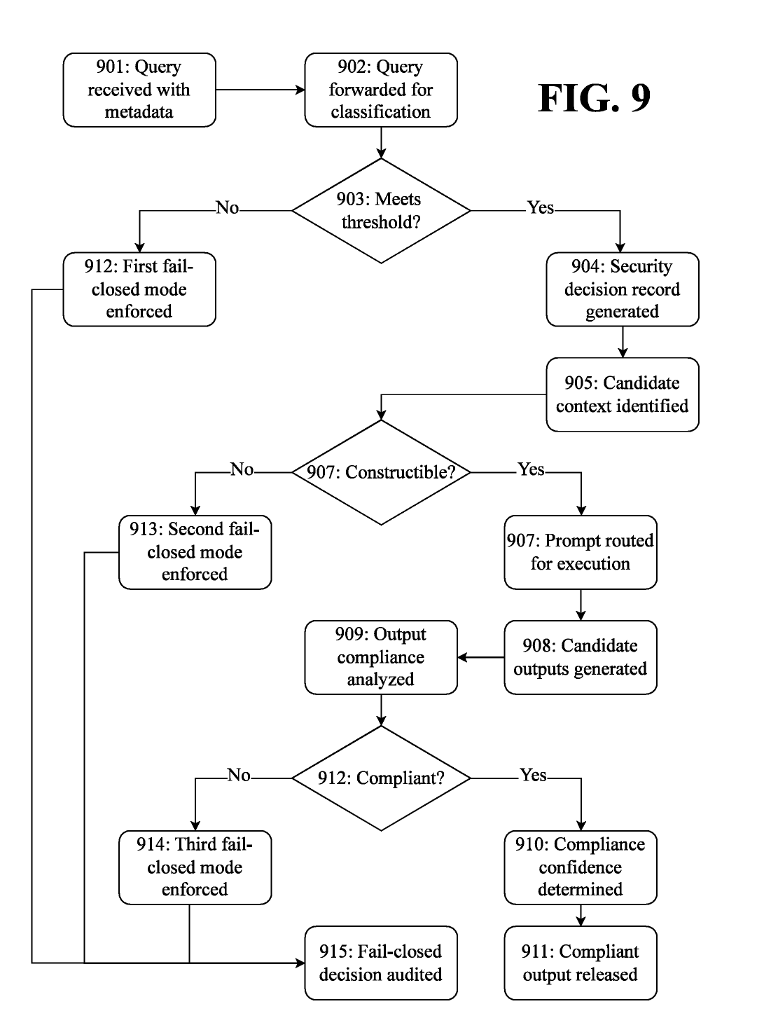

FIG. 9 is a flow diagram illustrating exemplary fail-closed decision making in a digital twinning platform 100, in an embodiment. The flow diagram depicts processing stages in which the platform 100 encounters uncertainty or constraint conditions that prevent confident determination of security, privacy, or compliance status, and responds by defaulting to restrictive enforcement postures at multiple decision points rather than permitting continued processing under uncertainty.

Processing begins when a query directed to a deployed digital twin instance is received at a client engagement layer 110 together with associated metadata including a user identifier, a tenant identifier, and a session identifier, step 901. The query and metadata are forwarded to a security classification engine 120 for evaluation, step 902.

The security classification engine 120 performs an initial classification of the query and associated metadata and determines whether classification confidence associated with the query satisfies a predefined threshold derived from applicable policy rules or configuration parameters, step 903. When classification confidence satisfies the predefined threshold, the security classification engine 120 generates a security decision record specifying sensitivity labels, permitted data sources, permitted model classes, required data transformations, and required compliance actions, step 904. A secure routing and context construction subsystem 130 receives the security decision record and identifies and evaluates candidate contextual data associated with the deployed digital twin instance, step 905.

The secure routing and context construction subsystem 130 determines whether a compliant prompt package can be constructed in accordance with constraints specified in the security decision record, step 906. When a compliant prompt package can be constructed, the secure routing and context construction subsystem 130 constructs the prompt package and routes the prompt package to an execution environment determined by the security decision record, step 907. An artificial intelligence execution layer 140 receives the prompt package and generates one or more candidate outputs using an artificial intelligence model within the routed execution environment, step 908. Generated candidate outputs are forwarded to a response compliance layer 150, which performs compliance analysis to evaluate whether each candidate output satisfies applicable security, privacy, and regulatory constraints with sufficient confidence under applicable policy rules, step 909.

The response compliance layer 150 determines whether compliance of the candidate output can be verified with sufficient confidence, step 910. When compliance is verified, the response compliance layer 150 releases the compliant candidate output to the client engagement layer 110 for delivery to a requesting user, step 911.

When classification confidence does not satisfy the predefined threshold at step 903, the security classification engine 120 invokes a first fail-closed enforcement mode, step 912. In the first fail-closed enforcement mode, a security decision record is generated that reduces permitted execution privileges in accordance with applicable policy rules, for example by restricting execution to a private model execution environment 142, limiting accessible contextual data, requiring enhanced logging, or requiring human review.

When a compliant prompt package cannot be constructed at step 906, the secure routing and context construction subsystem 130 invokes a second fail-closed enforcement mode, step 913. In the second fail-closed enforcement mode, execution may be blocked, execution may be restricted to a more constrained execution environment, or processing may be escalated for human approval, depending on applicable policy requirements.

When compliance of the candidate output cannot be verified with sufficient confidence at step 910, the response compliance layer 150 invokes a third fail-closed enforcement mode, step 914. In the third fail-closed enforcement mode, output delivery may be blocked, the candidate output may be escalated for human review, or a restricted response may be returned indicating that the requested operation cannot be completed under current security, privacy, or regulatory constraints.

Each fail-closed determination invoked at step 912, step 913, or step 914 is recorded by an audit and evidence subsystem 160 as an audit artifact capturing the processing stage at which the fail-closed enforcement mode was invoked, the applicable security decision record or classification result, the enforcement posture selected, and applicable policy version identifiers, step 915. Audit artifacts associated with fail-closed determinations are stored in a tamper-evident data store to support subsequent supervisory review, compliance reporting, or forensic analysis.

In an embodiment, the fail-closed enforcement decision paths illustrated in FIG. 9 are applicable to processing of queries directed to deployed artificial intelligence agent instances that are not configured as digital twins. In such embodiments, the first fail-closed enforcement mode at step 912, the second fail-closed enforcement mode at step 913, and the third fail-closed enforcement mode at step 914 are each invoked under the same conditions and apply the same restrictive enforcement postures as described with respect to FIG. 9, regardless of the type of artificial intelligence agent instance involved.

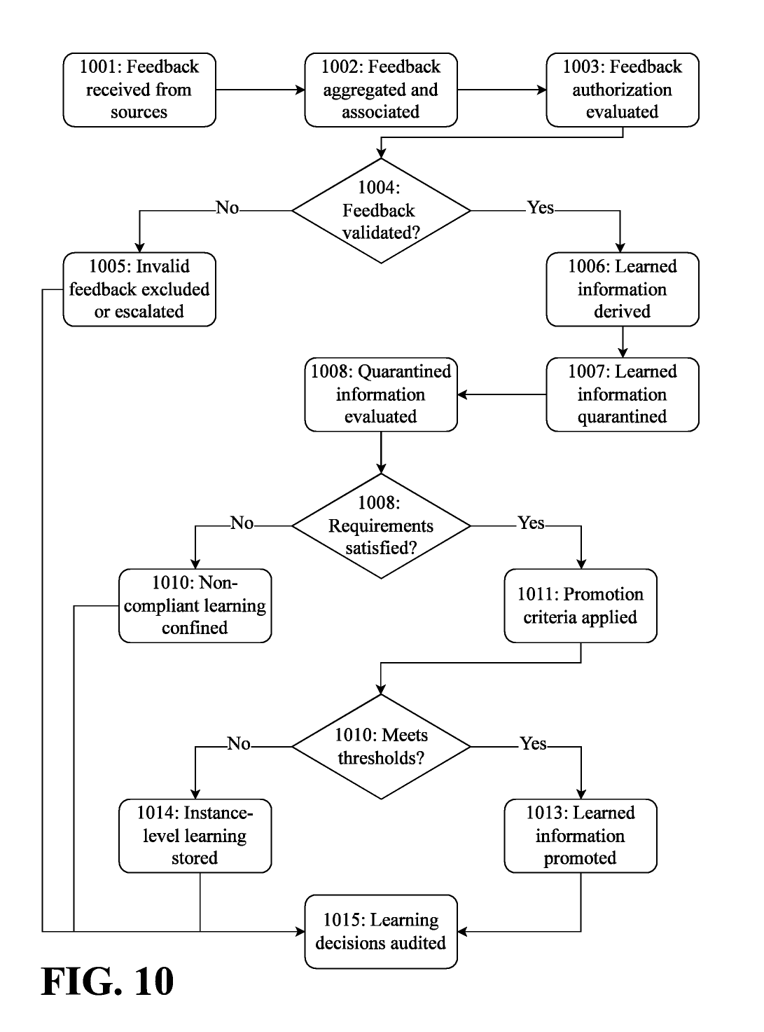

FIG. 10 is a flow diagram illustrating exemplary secure learning and feedback integration in a digital twinning platform 100, in an embodiment. The flow diagram depicts processing stages through which feedback and interaction-derived data are received, validated, quarantined, evaluated against security, privacy, and compliance constraints, and either promoted for subsequent use or confined to restricted storage, with audit artifacts generated at decision points to preserve traceability and governance of learning operations.

Processing begins when feedback is received from one or more sources including a client engagement layer 110 in the form of explicit user feedback, a response compliance layer 150 in the form of supervisory review outcomes, or an artificial intelligence execution layer 140 in the form of implicit interaction-derived signals, step 1001. A feedback reception interface 710 of a secure learning and feedback integration subsystem 170 aggregates feedback received from these sources and associates the feedback with specific interactions, digital twin instances, tenants, or knowledge domains, step 1002. A feedback validation engine 720 evaluates each received feedback signal by verifying that the feedback source is authorized to provide feedback for the associated digital twin instance, tenant, or knowledge domain, and by applying consistency checks to determine whether the feedback conflicts with previously validated information, security decision records, or applicable policy rules, step 1003.

The feedback validation engine 720 determines whether the feedback can be validated in accordance with applicable security and compliance constraints, step 1004. When feedback cannot be validated or conflicts with applicable constraints, the feedback validation engine 720 excludes the feedback from further learning processing or escalates the feedback for additional review, step 1005. When feedback is validated, the secure learning and feedback integration subsystem 170 derives learned information from the validated feedback, step 1006. Derivation of learned information may include, for example, aggregation of feedback signals, extraction of features or summaries, adjustment of prompt parameters, or generation of metadata suitable for controlled reuse. The derived learned information is placed in a quarantine state by a learning quarantine 730 and isolated from use in subsequent query processing pending completion of security and compliance evaluation, step 1007.

A security and compliance evaluator 740 receives the quarantined learned information together with applicable policy rules, compliance constraints, and, in some embodiments, a security decision record governing learning operations, and evaluates whether the learned information contains sensitive data, regulated content, or policy-restricted elements, step 1008. Evaluation may include reclassification of the learned information and application of transformation techniques such as de-identification, anonymization, aggregation, or abstraction to reduce sensitivity while preserving utility.

The security and compliance evaluator 740 determines whether the quarantined learned information satisfies applicable security and compliance requirements, step 1009. When the learned information does not satisfy applicable requirements, the security and compliance evaluator 740 designates the learned information as restricted or rejected and stores the non- promoted learning record in a tenant-isolated data store 770, step 1010. Restricted learning records may be retained for evidentiary or instance-limited purposes, while rejected learning records are prevented from use in subsequent query processing to avoid unauthorized reuse.

When the learned information satisfies applicable requirements, a controlled promotion logic 750 applies promotion criteria including aggregation thresholds, anonymity criteria, and policy conditions governing whether the learned information may be promoted beyond instance- level use, step 1011. The controlled promotion logic 750 determines whether the compliant learned information meets applicable promotion thresholds, step 1012. When the learned information meets promotion thresholds, the controlled promotion logic 750 promotes the learned information for use in subsequent query processing by providing the promoted information to a security classification engine 120 to support adaptive classification behavior or to data stores 132 to update contextual knowledge associated with deployed digital twin instances, step 1013. When the learned information does not meet promotion thresholds, the controlled promotion logic 750 stores the learned information as instance-level learning in a tenant-isolated data store 770, step 1014, where the information remains available for use within the scope of the specific tenant or digital twin instance from which it was derived but is not propagated to shared models or knowledge representations.

Each outcome at step 1005, step 1010, step 1013, or step 1014 is recorded by a learning audit artifact generator 760 as an audit artifact capturing the source of feedback, the characteristics of derived learned information, security classifications applied, transformation steps performed, and the promotion, instance-level confinement, restriction, or exclusion decision, step 1015. Generated audit artifacts are provided to an audit and evidence subsystem 160 for tamper-evident storage and for availability to authorized supervisory, compliance, or forensic review processes.

In an embodiment, the secure learning and feedback integration processing flow illustrated in FIG. 10 is applicable to management of feedback and learning updates derived from interactions with deployed artificial intelligence agent instances that are not configured as digital twins. In such embodiments, each processing stage from feedback reception at step 1001 through audit artifact generation at step 1015, including feedback validation, quarantine, security and compliance evaluation, controlled promotion, instance-level confinement, and rejection, operates as described with respect to FIG. 10 regardless of the type of artificial intelligence agent instance from which the feedback or interaction data is derived.

### Exemplary Computing Environment

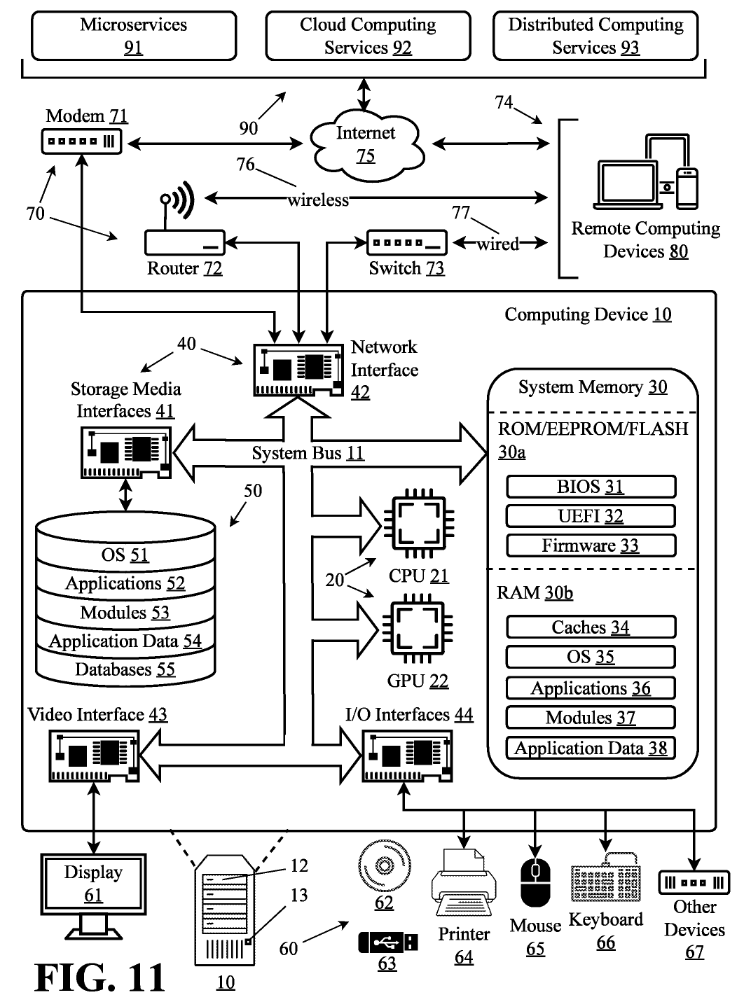

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud- based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure. Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 ("Firewire") interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as "flash drives" or "thumb drives") 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field- programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as "flash memory"). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low- latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non- volatile data storage device 50. Network interface 42 provides the necessary hardware interface for computing device lOto communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high- performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non- removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor- executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service.

While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer- executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computing system for an artificial intelligence (AI) agent platform, the computing system comprising:one or more hardware processors configured for:receiving, through a client engagement layer, a query directed to a deployed Al agent instance, wherein the query is received together with metadata comprising at least a user identifier, a tenant identifier, and a session identifier;classifying, by a security classification engine executing on the one or more hardware processors, the query and the metadata to generate a security decision record, wherein the security decision record specifies at least one of: a sensitivity label, a permitted data source, a permitted model class, a required data transformation, or a required compliance action;constructing, based on the security decision record, a prompt package comprising only contextual data elements authorized by the security decision record;routing, based on the security decision record, the prompt package to at least one of:a
private model execution environment hosted within secure infrastructure, or an external model execution environment accessed over a network;generating, by an Al model within the routed execution environment, a candidate output responsive to the prompt package;analyzing, by a response compliance layer executing on the one or more hardware
processors, the candidate output to detect whether the candidate output violates a security constraint, a privacy constraint, or a regulatory constraint;applying, when a violation is detected, an enforcement action to the candidate output,
wherein the enforcement action comprises at least one of: redacting a portion of the candidate output, rewriting the candidate output, regenerating the candidate output using an alternative
model, escalating the candidate output for human review, or blocking the candidate output;
and releasing, to the client engagement layer for delivery to a user, only a candidate output that satisfies applicable security, privacy, and regulatory requirements.

2. The computing system of claim 1, wherein the one or more hardware processors are further
configured for generating, for each query processed by the system, an audit artifact comprising
the security decision record, a routing decision, a model identifier, a policy version identifier, and an indication of any enforcement action applied, and storing the audit artifact in a tamper- evident data store using cryptographic hash chaining.

3. The computing system of claim 1, wherein classifying the query and the metadata comprises
applying a machine-learned classifier to identify a sensitive information category, and validating an output of the machine-learned classifier against an explicit policy rule to generate the security decision record.

4. The computing system of claim 1, wherein constructing the prompt package comprises retrieving candidate contextual data elements from a data store associated with the deployed Al
agent instance, evaluating each candidate contextual data element against the security decision record, and excluding from the prompt package each candidate contextual data element not authorized by the security decision record.

5. The computing system of claim 1, wherein routing the prompt package comprises routing to the private model execution environment when the sensitivity label specified in the security
decision record indicates presence of protected information, and applying the required data transformation to the prompt package prior to routing to the external model execution environment.

6. The computing system of claim 1, wherein the one or more hardware processors are further configured for, when the security classification engine cannot classify the query with a
classification confidence level meeting a predefined threshold, defaulting to a fail-closed mode comprising routing the prompt package exclusively to the private model execution environment.

7. The computing system of claim 1, wherein the one or more hardware processors are further configured for receiving learned information derived from an interaction with the deployed Al agent instance, placing the learned information in a quarantine state, evaluating the learned
information against the security decision record during the quarantine state, and promoting the learned information for use in subsequent query processing only when the learned information satisfies requirements specified in the security decision record.

8. The computing system of claim 1, wherein routing the prompt package comprises executing a hybrid execution strategy in which the private model execution environment processes contextual data elements associated with the sensitivity label to generate an intermediate representation, and the external model execution environment generates the candidate output
based on the intermediate representation.

9. The computing system of claim 1, wherein the deployed Al agent instance comprises a digital twin instance configured as an artificial intelligence-driven representation of a subject.

10. A computer-implemented method for enforcing security and compliance during operation of an artificial intelligence (AI) agent platform, the method comprising:receiving, through a client engagement layer, a query directed to a deployed Al agent instance, wherein the query is received together with metadata comprising at least a user identifier, a tenant identifier, and a session identifier;classifying, by a security classification engine executing on one or more hardware processors, the query and the metadata to generate a security decision record, wherein the
security decision record specifies at least one of: a sensitivity label, a permitted data source, a permitted model class, a required data transformation, or a required compliance action;constructing, based on the security decision record, a prompt package comprising only contextual data elements authorized by the security decision record;routing, based on the security decision record, the prompt package to at least one of: a private
model execution environment hosted within secure infrastructure, or an external model execution environment accessed over a network;generating, by an Al model within the routed execution environment, a candidate output responsive to the prompt package;analyzing, by a response compliance layer executing on the one or more hardware
processors, the candidate output to detect whether the candidate output violates a security constraint, a privacy constraint, or a regulatory constraint;applying, when a violation is detected, an enforcement action to the candidate output,
wherein the enforcement action comprises at least one of: redacting a portion of the candidate output, rewriting the candidate output, regenerating the candidate output using an alternative
model, escalating the candidate output for human review, or blocking the candidate output; and
releasing, to the client engagement layer for delivery to a user, only a candidate output that satisfies applicable security, privacy, and regulatory requirements.

11. The method of claim 10, wherein the deployed AI agent instance comprises a digital twin instance configured as an artificial intelligence-driven representation of a subject.

12. The method of claim 10, further comprising generating, for each query processed, an audit artifact comprising the security decision record, a routing decision, a model identifier, a policy version identifier, and an indication of any enforcement action applied, and storing the audit artifact in a tamper-evident data store using cryptographic hash chaining.

13. The method of claim 10, wherein classifying the query and the metadata comprises applying
a machine-learned classifier to identify a sensitive information category, and validating an output of the machine-learned classifier against an explicit policy rule to generate the security decision record.

14. The method of claim 10, wherein constructing the prompt package comprises retrieving candidate contextual data elements from a data store associated with the deployed AI agent
instance, evaluating each candidate contextual data element against the security decision record,
and excluding from the prompt package each candidate contextual data element not authorized by the security decision record.

15. The method of claim 10, wherein routing the prompt package comprises routing to the private model execution environment when the sensitivity label specified in the security decision
record indicates presence of protected information, and applying the required data transformation to the prompt package prior to routing to the external model execution environment.

16. The method of claim 10, further comprising, when the security classification engine cannot classify the query with a classification confidence level meeting a predefined threshold,
defaulting to a fail-closed mode comprising routing the prompt package exclusively to the
private model execution environment.

17. The method of claim 10, further comprising receiving learned information derived from an interaction with the deployed AI agent instance, placing the learned information in a quarantine state, evaluating the learned information against the security decision record during the
quarantine state, and promoting the learned information for use in subsequent query processing only when the learned information satisfies requirements specified in the security decision record.

18. The method of claim 10, wherein routing the prompt package comprises executing a hybrid
execution strategy in which the private model execution environment processes contextual data elements associated with the sensitivity label to generate an intermediate representation, and the external model execution environment generates the candidate output based on the intermediate representation.
